(19) United States
(12) Patent Application Publication
(10) Pub. No.: US 2025/0362433 A1
(43) Pub. Date: Nov. 27, 2025

(54) COMPOUND, ANTIREFLECTION FILM COMPRISING THE SAME AND DISPLAY DEVICE

(71) Applicant: SAMSUNG SDI CO., LTD., Yongin-si, Gyeonggi-do (KR)

(72) Inventors: Euisoo JEONG, Suwon-si, Gyeonggi-do (KR); Insub SHIN, Suwon-si, Gyeonggi-do (KR); Heejo MOON, Suwon-si, Gyeonggi-do (KR); Chang-Hyun KWON, Suwon-si, Gyeonggi-do (KR); Jeehyun RYU, Suwon-si, Gyeonggi-do (KR); Baek Soung PARK, Suwon-si, Gyeonggi-do (KR)

(21) Appl. No.: 18/867,949

(22) PCT Filed: Oct. 24, 2022
(86) PCT No.: PCT/KR2022/016256

§ 371 Date: Nov. 21, 2024

(30) Foreign Application Priority Data
Aug. 19, 2022 (KR) 10-2022-0104215

(51) Int. Cl. G02B 1/11; C09B 62/483; C09J 7/24; C09J 7/29

(52) U.S. Cl. CPC G02B 1/11; C09B 62/483; C09J 7/24; C09J 7/29

(57) ABSTRACT

Provided are a compound represented by Chemical Formula 1, an antireflection film including the same, and a display device including the antireflection film.

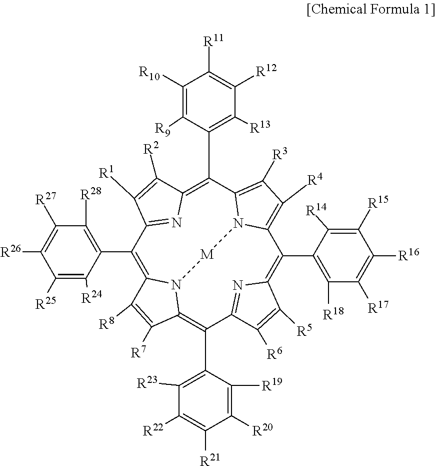

(In Chemical Formula 1, each substituent is the same as defined in the detailed description.)

### TECHNICAL FIELD

This disclosure relates to a compound, an antireflection film comprising the compound, and a display device comprising the antireflection film.

### BACKGROUND ART

In the field of novel displays using luminescent materials (e.g., quantum dots, organic inorganic phosphors. etc.) as well as conventional liquid crystal displays such as LCDs, etc., an antireflection film is applied to improve external light reflection caused by scatterers.

A dye-type antireflection film, in order to prevent the external light reflection and light emission of panel constituent materials, uses a dye absorbing and blocking light in a specific absorption wavelength region.

In particular, in the novel display field, research on introducing an antireflection film to which functions such as (particularly, blue) luminance loss suppression and color correction are added is being made. Specifically, a dye absorbing and blocking mixed light of Violet/Cyan/Neon/Near-IR to minimize RGB color purity deterioration of a panel as well as lowering light reflectance of the entire absorption wavelength region may be applied to the antireflection film

In this regard, cyanine-based dyes, azo-based dyes, and the like are known but may absorb light of a short wavelength region alone and also have a problem in terms of light resistance reliability.

### DISCLOSURE

### Technical Problem

An embodiment provides a compound having excellent properties such as solubility, release resistant properties, and migration inhibition while ensuring light resistance reliability.

Another embodiment provides an antireflection film including the compound.

Another embodiment provides a display device including the antireflection film.

### Technical Solution

An embodiment provides a compound represented by Chemical Formula 1.

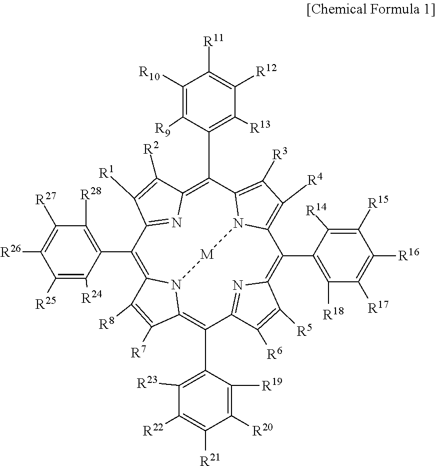

In Chemical Formula 1,
M is two hydrogen atoms, a divalent metal atom, a trivalent substituted metal atom, a tetravalent substituted metal atom, a hydroxide metal atom, or a metal oxide atom;
R¹ to R⁸ are each independently a hydrogen atom, a halogen atom, a cyano group, a carbonyl group, or a nitro group;
R⁹ to R²⁸ are each independently a substituted or unsubstituted C1 to C20 alkyl group, a substituted or unsubstituted C1 to C20 alkoxy group, *—C(═O)OR (R is a substituted or unsubstituted C1 to C15 alkyl group), a substituted or unsubstituted C3 to C20 cycloalkyl group, or a substituted or unsubstituted C6 to C20 aryl group; and
at least one of R⁹ to R²⁸ is a C1 to C20 alkoxy group having a terminal end substituted with a (meth)acrylate group.

The M may be V(═O), Cu, Co, Zn, or Ag.

All of R¹ to R⁸ may be hydrogen atoms.

At least two of R⁹ to R¹³, one or two or more of R¹⁴ to R¹⁸, at least two of R¹⁹ to R²³, and one or two or more of R²⁴ to R²⁸ may each a substituted or unsubstituted C1 to C20 alkoxy group, wherein at least one of R⁹ to R²⁸ may be substituted at the terminal end with a (meth)acrylate group.

Among R⁹ to R¹³, two or more functional groups which are substituted or unsubstituted C1 to C20 alkoxy groups may be bonded to each other in an ortho position, and among R¹⁹ to R²³, two or more functional groups which are substituted or unsubstituted C1 to C20 alkoxy groups may be bonded to each other in an ortho position.

The compound can be represented by Chemical Formula 1-1 or 1-2:

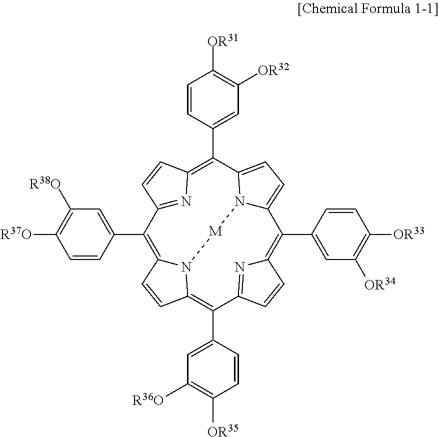

In Chemical Formula 1-1,
R³¹ to R³⁸ are each independently a hydrogen atom, a substituted or unsubstituted C1 to C20 alkyl group, a substituted or unsubstituted C1 to C20 alkoxy group, *—C(═O)OR (R is a substituted or unsubstituted C1 to C15 alkyl group), a substituted or unsubstituted C3 to C20 cycloalkyl group, or a substituted or unsubstituted C6 to C20 aryl group; and
at least one of R³¹ to R³⁸ is a C1 to C20 alkyl group having a terminal end substituted with

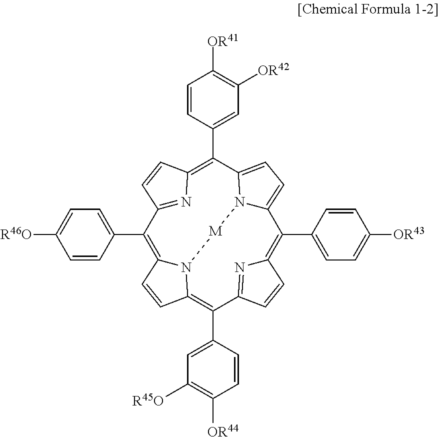

wherein, in Chemical Formula 1-2,
R⁴¹ to R⁴⁶ are each independently a hydrogen atom, a substituted or unsubstituted C1 to C20 alkyl group, a substituted or unsubstituted C1 to C20 alkoxy group, *—C(═O)OR (R is a substituted or unsubstituted C1 to C15 alkyl group), a substituted or unsubstituted C3 to C20 cycloalkyl group, or a substituted or unsubstituted C6 to C20 aryl group; and
at least one of R⁴¹ to R⁴⁶ is a C1 to C20 alkyl group having a terminal end substituted with (meth)acrylate.

At least two of R³¹ to R³⁸ may be a C1 to C10 alkyl group having a terminal end substituted with (meth)acrylate.

Among R³¹ to R³⁸, the functional group other than a C1 to C10 alkyl group having a terminal end substituted with (meth)acrylate may be a C4 to C10 branched alkyl group.

At least two of R⁴¹ to R⁴⁶ may be a C1 to C10 alkyl group having a terminal end substituted with (meth)acrylate.

Among R⁴¹ to R⁴⁶, a functional group other than a C1 to C10 alkyl group having a terminal end substituted with (meth)acrylate may be a C4 to C10 branched alkyl group.

The compound may be selected from the group including:

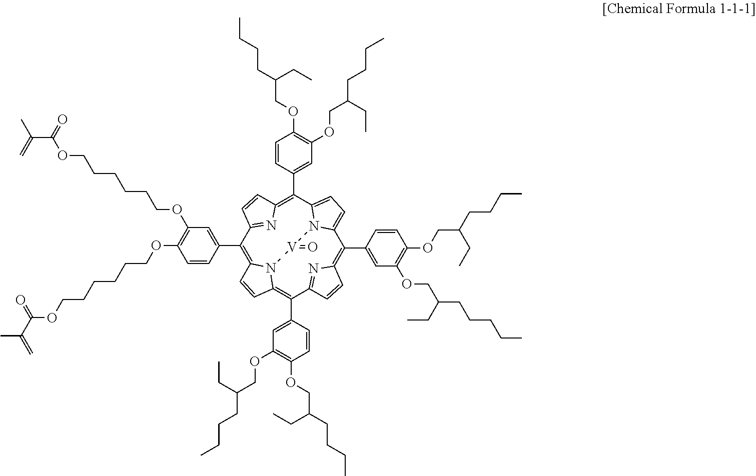

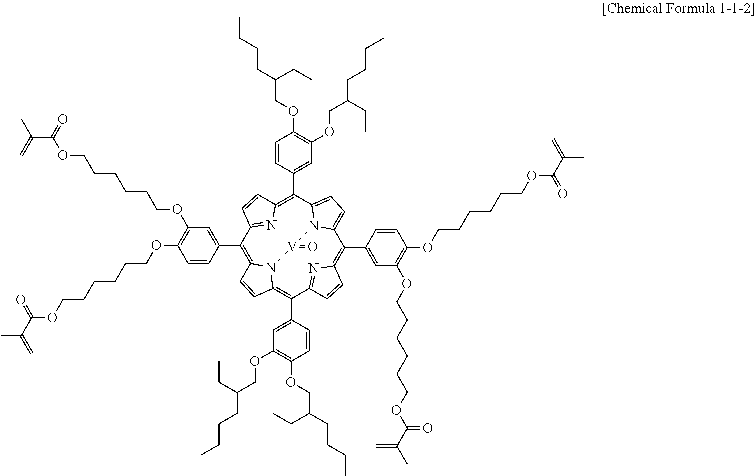

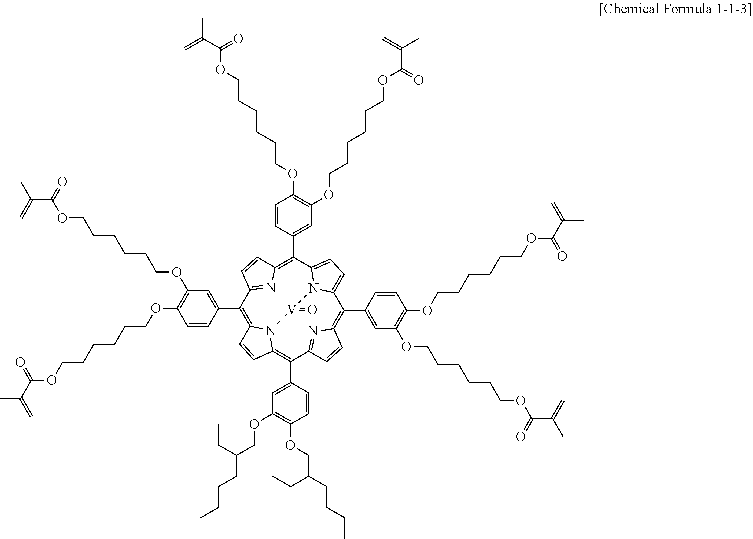

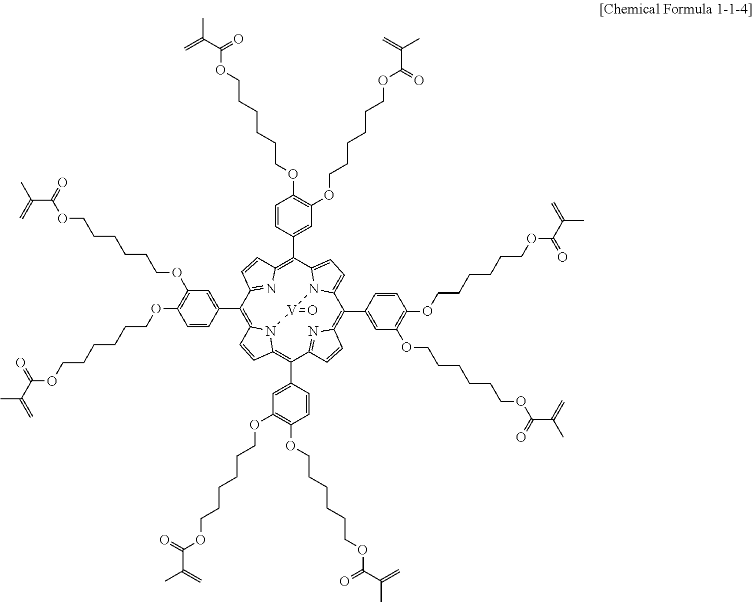

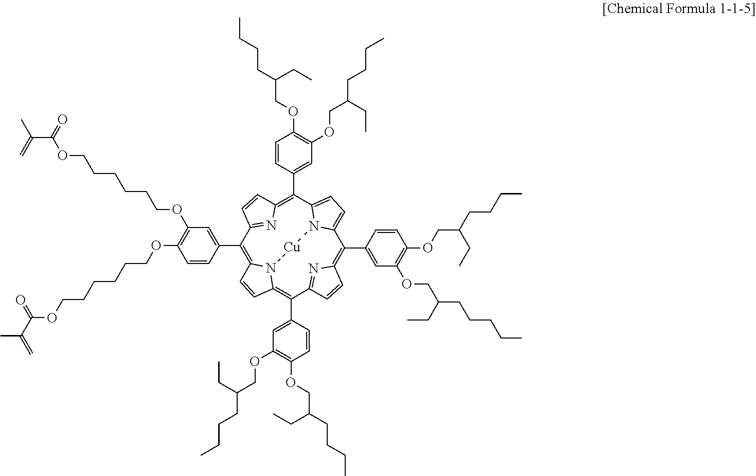

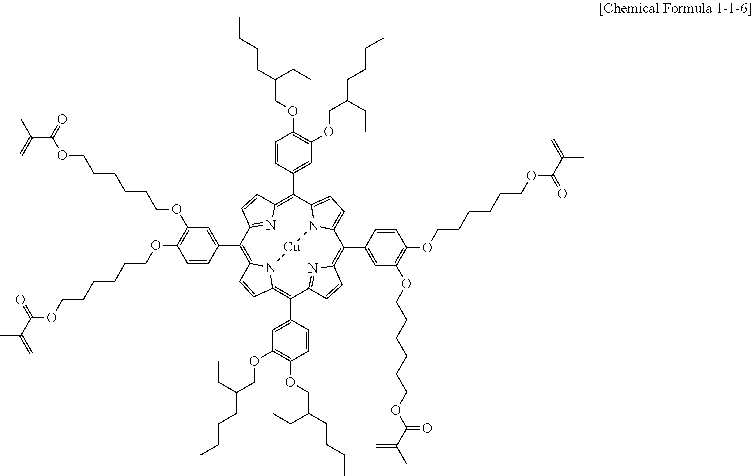

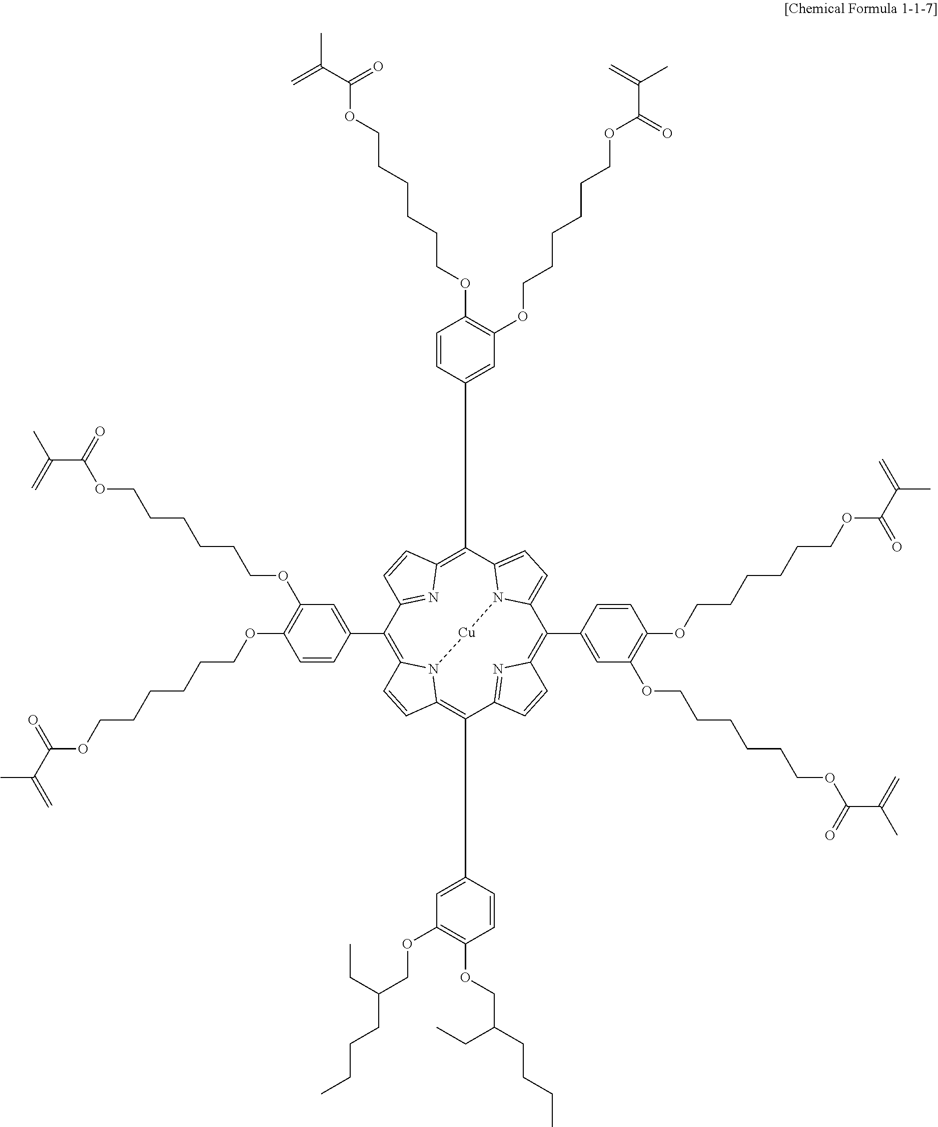

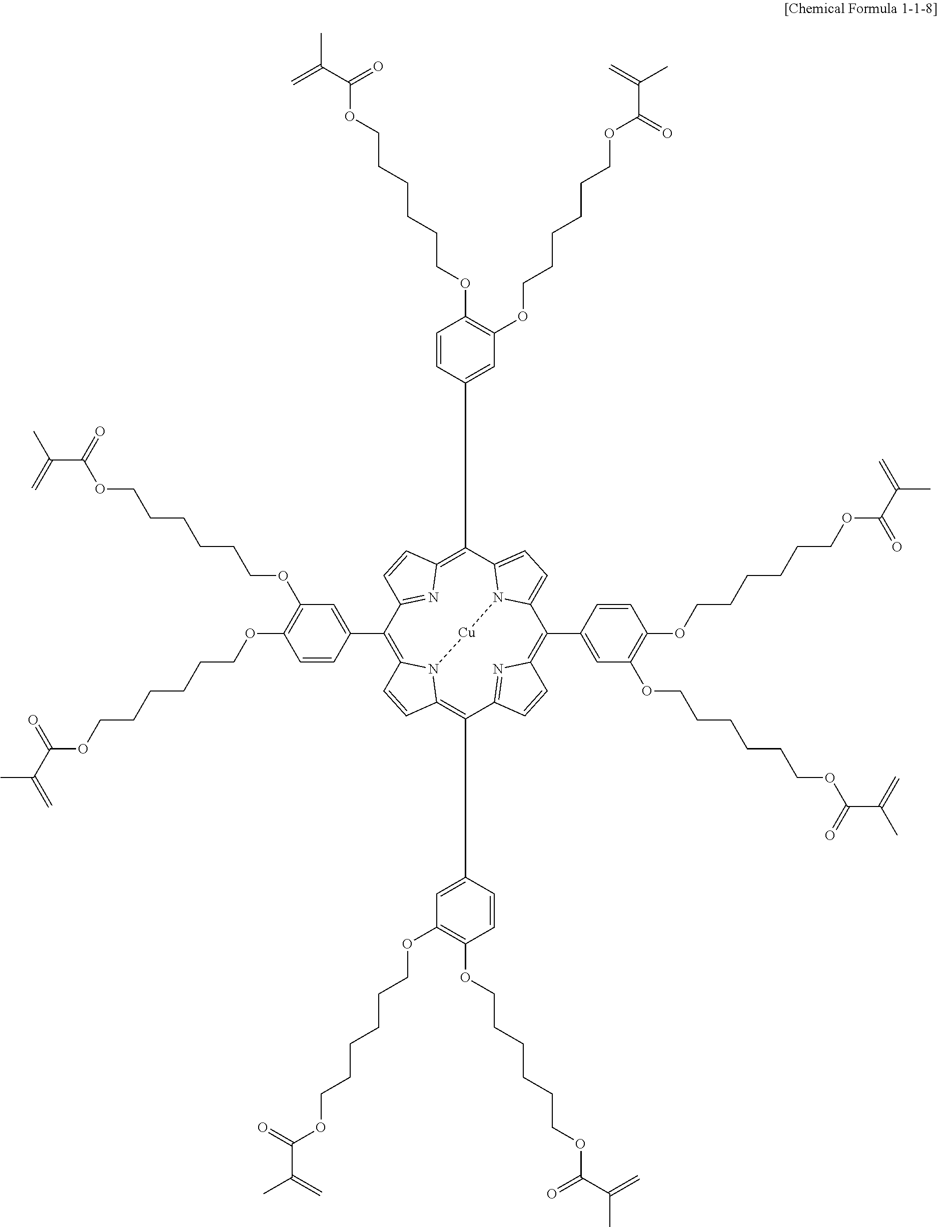

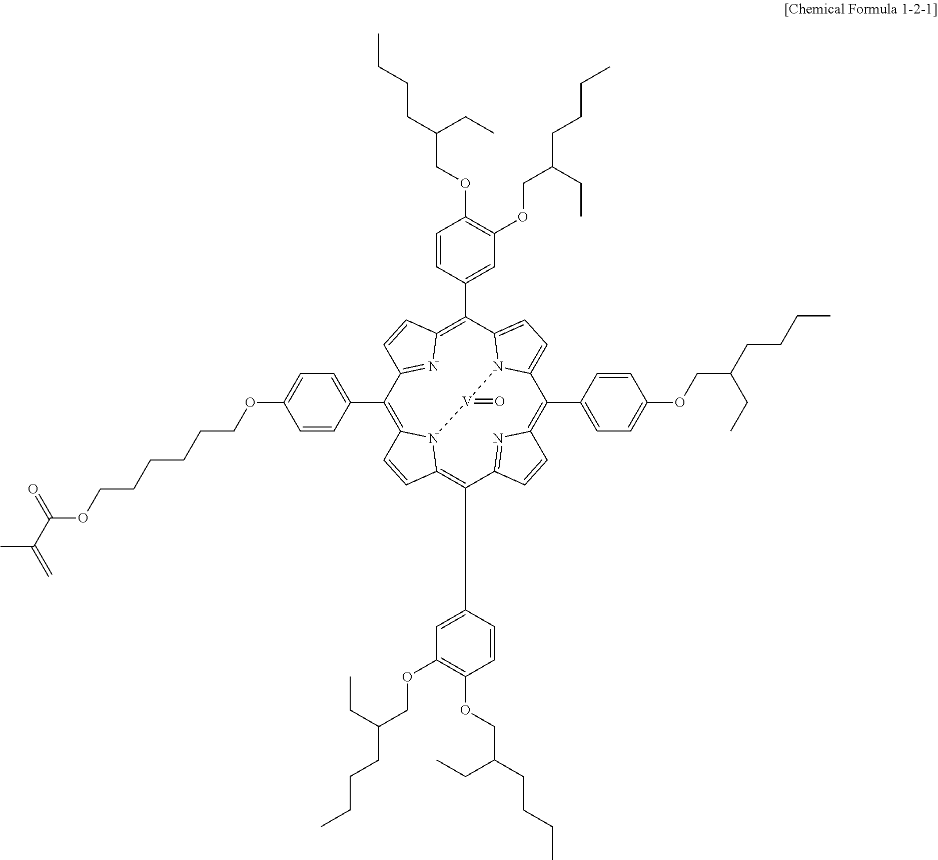

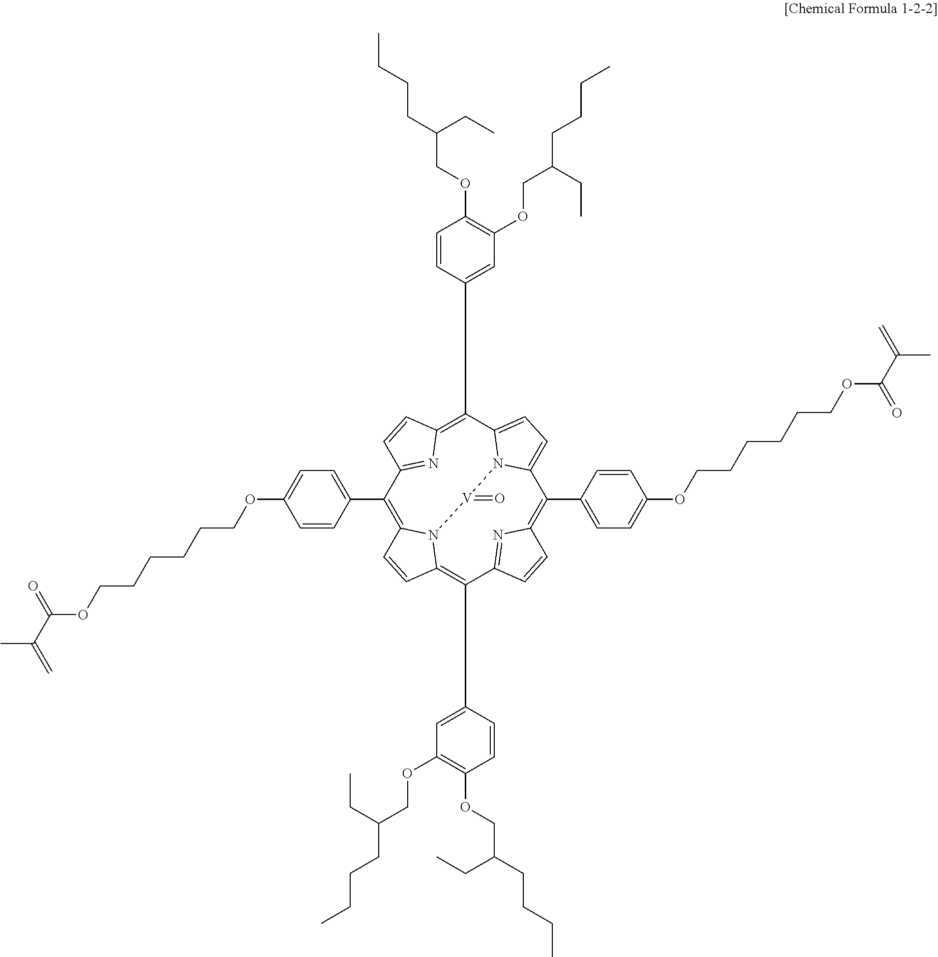

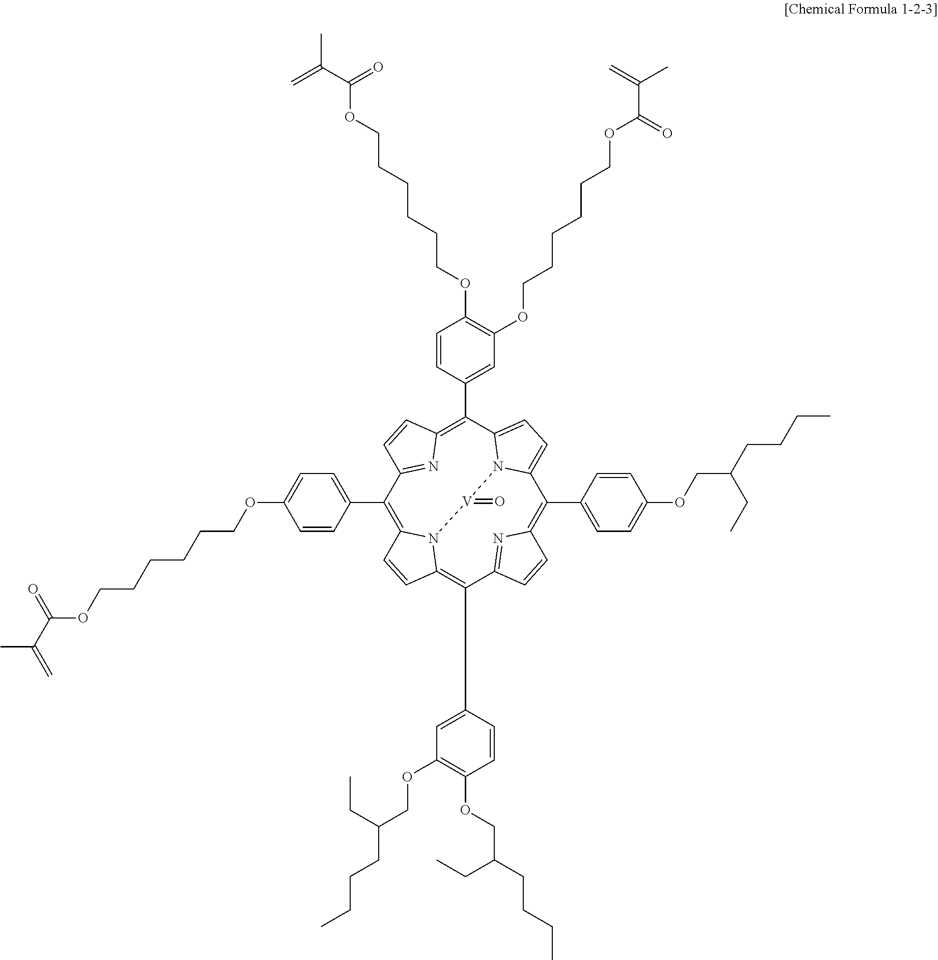

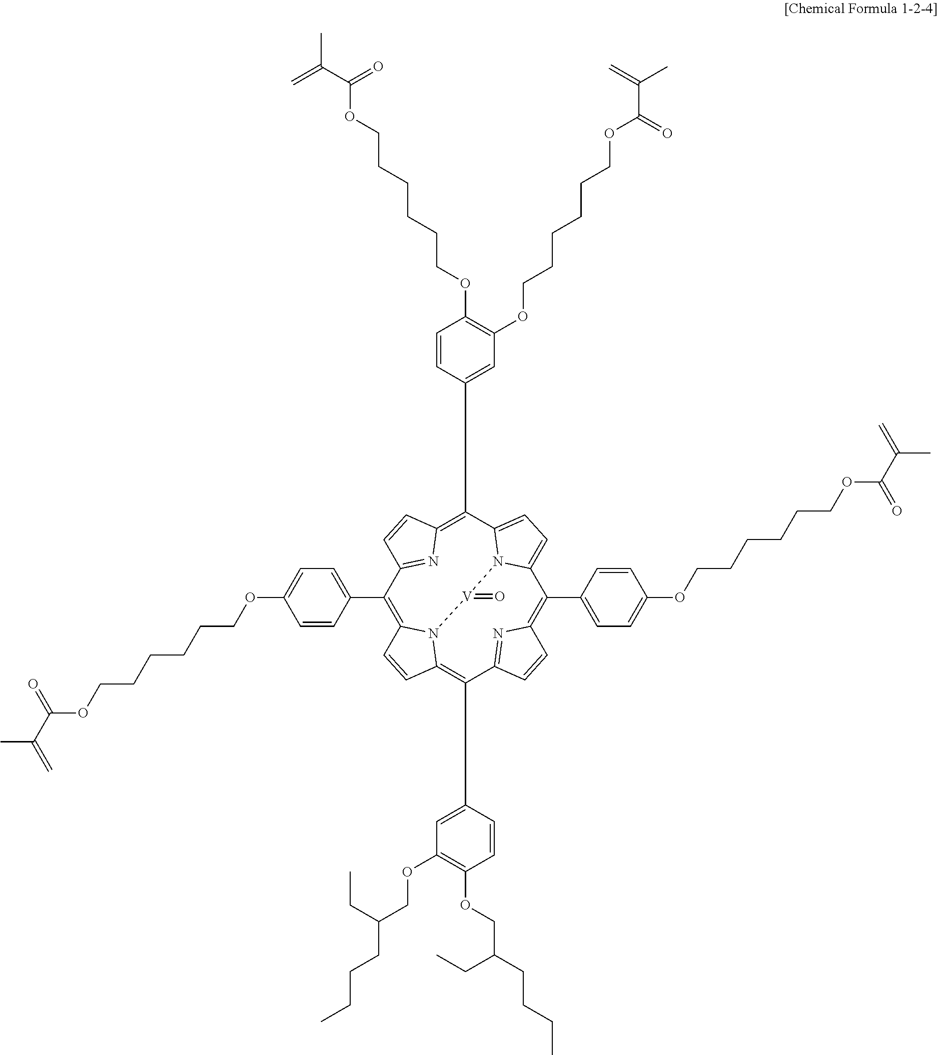

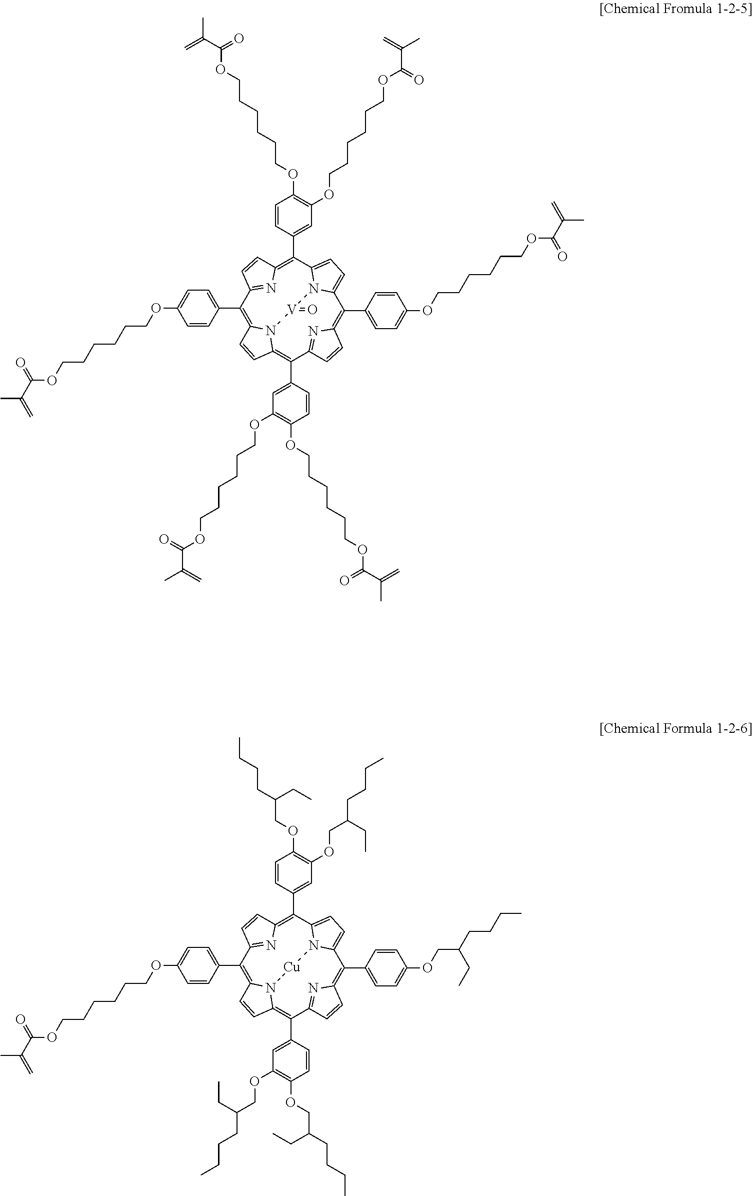

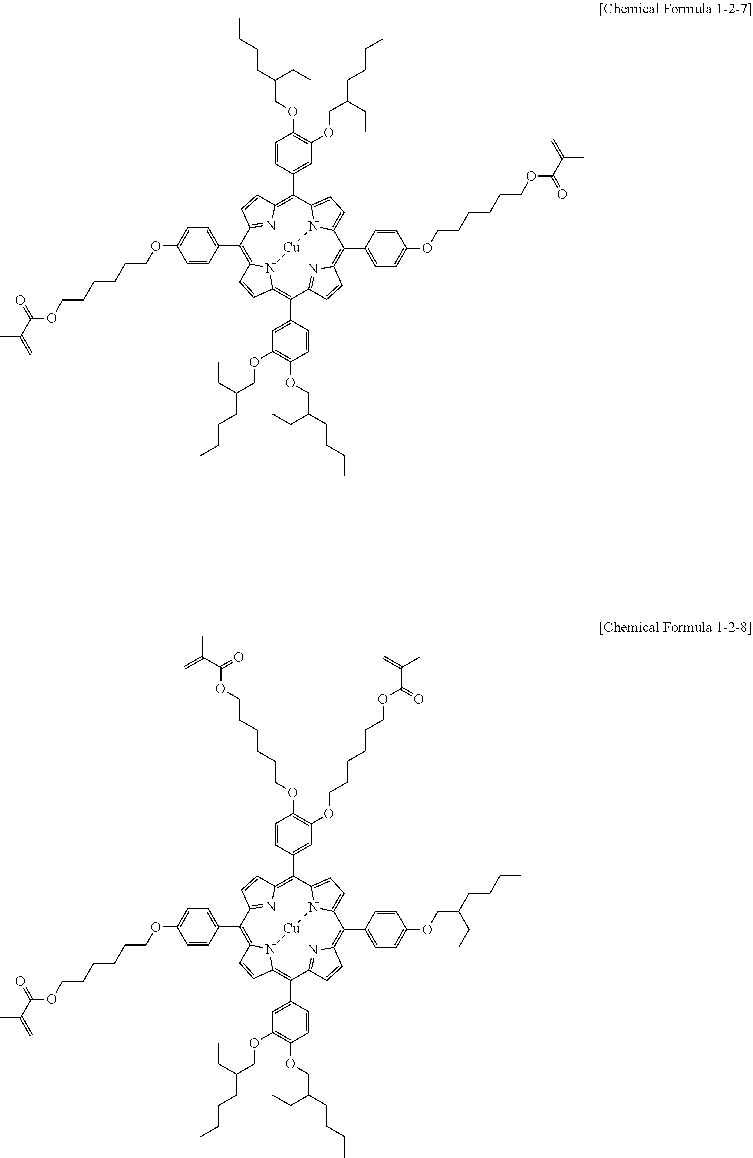

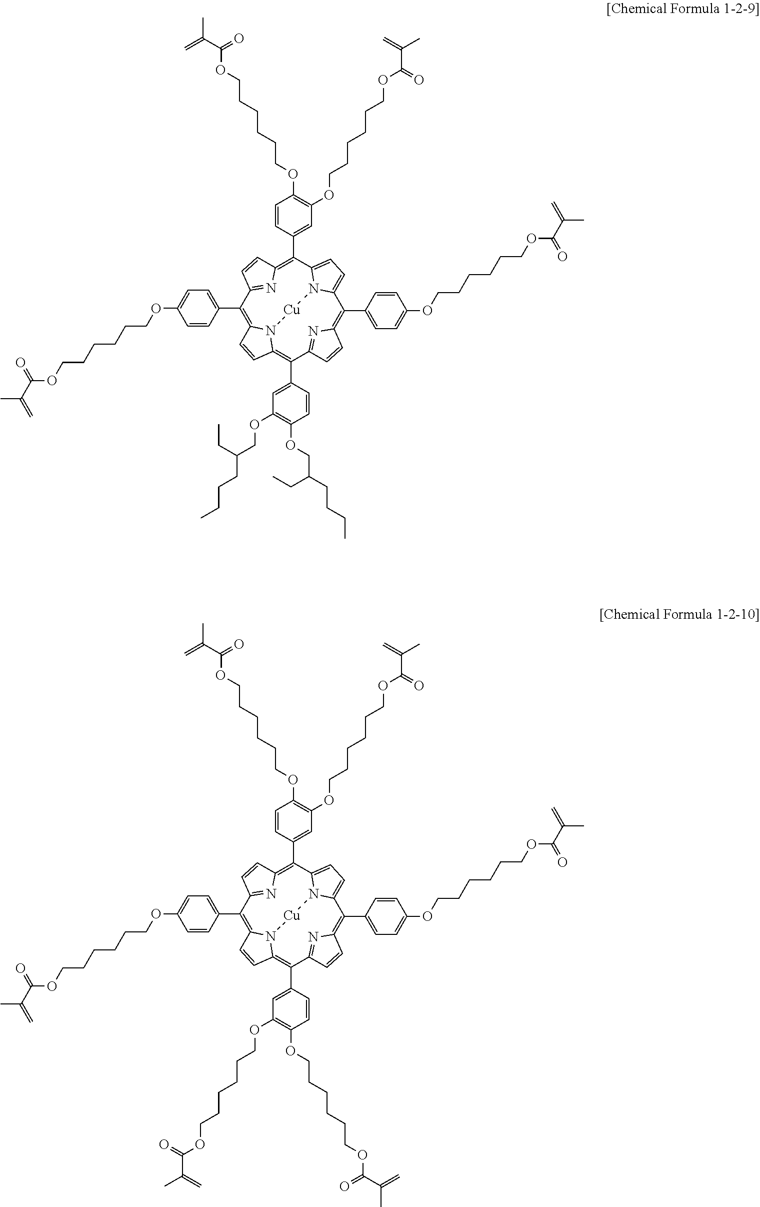

A maximum absorption wavelength (λₘₐₓ) of the compound may be 420 nm to 440 nm.

The compound may be a color material for electronic materials.

Another embodiment provides an antireflection film including the compound.

The antireflection film may include an adhesive layer and an antireflection layer formed on the adhesive layer, and the compound may be included in the adhesive layer.

The antireflection film may include an adhesive layer, a dye-containing layer, and an antireflection layer formed on the dye-containing layer, and the compound may be included in the adhesive layer, the dye-containing layer, or both.

Another embodiment provides a display device including the antireflection film.

Other embodiments of the present invention are included in the following detailed description.

### Advantageous Effects

According to the above-mentioned embodiment, a compound has excellent properties such as solubility, release resistant properties, and migration inhibition while ensuring light resistance reliability. Accordingly, a display device including the compound of the above embodiment in an antireflection film can have suppressed luminance loss and improved panel color reproducibility.

### DESCRIPTION OF THE DRAWINGS

FIGS. 1 and 2 are schematic diagrams each independently showing an antireflection film according to an embodiment.

FIGS. 3 and 4 are schematic diagrams each independently showing a display device according to an embodiment.

### BEST MODE

Hereinafter, embodiments of the present invention are described in detail. However, these embodiments are exemplary, and this disclosure is not limited thereto.

As used herein, when specific definition is not otherwise provided, “alkyl group” refers to a C1 to C20 alkyl group, “alkenyl group” refers to a C2 to C20 alkenyl group, “cycloalkenyl group” refers to a C3 to C20 cycloalkenyl group, “heterocycloalkenyl group” refers to a C3 to C20 heterocycloalkenyl group, “aryl group” refers to a C6 to C20 aryl group, “arylalkyl group” refers to a C6 to C20 arylalkyl group, “alkylene group” refers to a C1 to C20 alkylene group, “arylene group” refers to a C6 to C20 arylene group, “alkylarylene group” refers to a C6 to C20 alkylarylene group, “heteroarylene group” refers to a C3 to C20 heteroarylene group, and “alkoxylene group” refers to a C1 to C20 alkoxylene group.

As used herein, when specific definition is not otherwise provided, “substituted” refers to replacement of at least one hydrogen atom of a compound by a substituent of a halogen atom (F, Cl, Br, or I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

Additionally, As used herein, when specific definition is not otherwise provided, “hetero” means that the chemical formula includes at least one heteroatom of at least one of N, O, S, and P.

As used herein, when specific definition is not otherwise provided, “(meth)acrylate” refers to both “acrylate” and “methacrylate”, and “(meth)acrylic acid” refers to “acrylic acid” and “methacrylic acid”.

As used herein, when specific definition is not otherwise provided, the term “combination” refers to mixing or copolymerization.

As used herein, when a definition is not otherwise provided, hydrogen is bonded at the position when a chemical bond is not drawn where supposed to be given.

When describing a numerical range in the present specification, “X to Y” means “X or more and Y or less” (X≤ and ≤Y).

In the present specification, when describing a range other than a numerical range, “X to Y” means “from X to Y.”

In this specification, the “maximum absorption wavelength (λₘₐₓ)” of a compound (dye) refers to the wavelength at which maximum absorbance appears when absorbance is measured for a solution of the compound (dye) at a concentration of 10 ppm in cyclohexanone. The above maximum absorbance may be measured according to methods known to those skilled in the art.

In this specification, “light resistance reliability” is evaluated by measuring the light transmittance at the maximum absorption wavelength of the dye before and after irradiation of the display device under the conditions of [light source lamp: Xenon lamp, irradiation intensity: 0.35 W/cm², irradiation temperature: 63° C., irradiation time: 500 hours, irradiation direction: irradiated toward the anti-reflection film] in a Xenon Test Chamber (Q-SUN), and then evaluating the change in light transmittance.

As used herein, when specific definition is not otherwise provided, “**” refers to a linking point with the same or different atom or chemical formula.

An embodiment provides a compound represented by Chemical Formula 1.

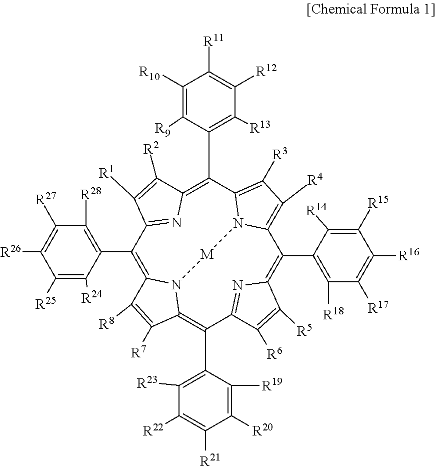

In Chemical Formula 1,
M is two hydrogen atoms, a divalent metal atom, a trivalent substituted metal atom, a tetravalent substituted metal atom, a hydroxide metal atom, or a metal oxide atom;
R¹ to R⁸ are each independently a hydrogen atom, a halogen atom, a cyano group, a carbonyl group, or a nitro group;
R⁹ to R²⁸ are each independently a substituted or unsubstituted C1 to C20 alkyl group, a substituted or unsubstituted C1 to C20 alkoxy group, *—C(═O)OR (R is a substituted or unsubstituted C1 to C15 alkyl group), a substituted or unsubstituted C3 to C20 cycloalkyl group, or a substituted or unsubstituted C6 to C20 aryl group; and
at least one of R⁹ to R²⁸ is a C1 to C20 alkoxy group having a terminal end substituted with a (meth)acrylate group.

In a typical liquid crystal display (LCD), light emitted from a white light source passes RGB color filters of each pixel to form subpixels of each color and combine them, thereby realizing colors within the RGB range.

Recently, development of novel displays using luminescent materials (e.g., quantum dots, organic/inorganic phosphors, etc.) emitting a color of each subpixel is being made. In this regard, a method of exciting the luminescent materials of each subpixel such as blue, green, red, etc. is being suggested, such as a method of using a UV light source, a method of using a blue light source, and the like.

Meanwhile, in order to improve the external light reflection due to scatterers in the novel displays as well as the conventional liquid crystal displays, an antireflection film is being introduced, and in particular, in the novel display field, research on introducing an antireflection film to which a (particularly, blue) luminance loss suppression function, a color correction function, etc. are added is being made.

Specifically, a dye, which is applied to the antireflection film, may be a dye absorbing and blocking mixed light of Violet (absorption wavelength region: 350 nm to 450 nm)/Cyan (absorption wavelength region: 480 nm to 520 nm)/Neon (absorption wavelength region: 530 nm to 670 nm)/Near-IR (absorption wavelength region: 605 nm to 790 nm) as well as lowering light reflectance of the entire absorption wavelength region in order to minimize RGB color purity deterioration of a panel. In addition, for the dye applied to the antireflection film, it is necessary to use a dye that has secured reliability for a change in light transmittance depending on conditions such as light resistance, heat resistance, moisture resistance, and the like.

In this regard, cyanine-based dyes, azo-based dyes, and the like are known, which may absorb light of a short wavelength region alone and also, have a problem with light resistance reliability.

The compound of one embodiment, which is a type of porphyrin-based dyes, may absorb light at a wavelength over three or more regions out of the mixed light through one compound.

Although described in more detail later, the compound of one embodiment may absorb light at a wavelength of 350 nm to 480 nm and 500 nm to 550 nm, wherein because the compound has a maximum absorption wavelength at 420 nm to 440 nm out of the absorption wavelength region, an antireflection film and a display device including the compound may be minimized from luminance (particularly, in a blue region) deterioration and secure light resistance reliability.

On the other hand, generally known porphyrin-based dyes have disadvantages of lowering solubility, release resistant properties, and the like and generating color transfer.

The compound of one embodiment is a type of the porphyrin-based dyes, but a C1 to C20 alkoxy group is introduced into at least one functional group among the R⁹ to R²⁸ to improve solubility. In addition, a (meth)acrylate group is introduced at the terminal end of at least one functional group among the R⁹ to R²⁸ to suppress the color transfer as well as improve release resistant properties.

In summary, the compound of one embodiment, which is one of the porphyrin-based dyes, may absorb light over three or more wavelength regions out of the mixed light to minimize RGB color purity deterioration of a panel as well as lower light reflectance of the entire absorption wavelength region and ultimately, suppress luminance loss of a display device including the compound of one embodiment in an antireflection film and improve color reproducibility of a panel.

Furthermore, the compound of the above embodiment can overcome the shortcomings of porphyrin dyes and achieve excellent properties such as solubility, light resistance reliability, release resistant properties, and migration inhibition by introducing a functional group, which is a C1 to C20 alkoxy group substituted at the terminal end with a (meth)acrylate group, to at least one of R⁹ to R²⁸.

Hereinafter, the compound of the embodiment will be described in more detail.

The M may be V(═O), Cu, Co, Zn, or Ag.

In particular, when the above M is V(═O), it can contribute to improving the characteristics such as light resistance reliability, release resistant properties, and migration inhibition.

All of R¹ to R⁸ may be hydrogen atoms.

When one or more polar functional groups are introduced to the benzene ring of a porphyrin-based dye, properties such as solubility, release resistant properties, and migration inhibition can be improved.

Specifically, at least two of R⁹ to R¹³, one or two or more of R¹⁴ to R¹⁸, at least two of R¹⁹ to R²³, and one or two or more of R²⁴ to R²⁸ may each be a substituted or unsubstituted C1 to C20 alkoxy group, wherein at least one of R⁹ to R²⁸ may be substituted at the terminal end with a (meth)acrylate group.

Here, two or more functional groups among R⁹ to R¹³ which are substituted or unsubstituted C1 to C20 alkoxy groups may be bonded to each other in an ortho position, and two or more functional groups among R¹⁹ to R²³ which are substituted or unsubstituted C1 to C20 alkoxy groups may be bonded to each other in an ortho position.

More specifically, the compound may be represented by Chemical Formula 1-1 or 1-2:

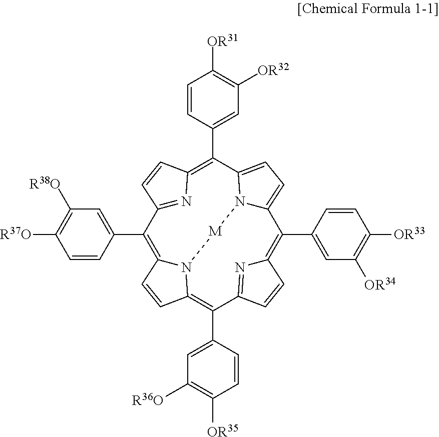

In Chemical Formula 1-1, PP2,1,

R³¹ to R³⁸ are each independently a hydrogen atom, a substituted or unsubstituted C1 to C20 alkyl group, a substituted or unsubstituted C1 to C20 alkoxy group, *—C(═O)OR (R is a substituted or unsubstituted C1 to C15 alkyl group), a substituted or unsubstituted C3 to C20 cycloalkyl group, or a substituted or unsubstituted C6 to C20 aryl group; and
at least one of R³¹ to R³⁸ is a C1 to C20 alkyl group having a terminal end substituted with

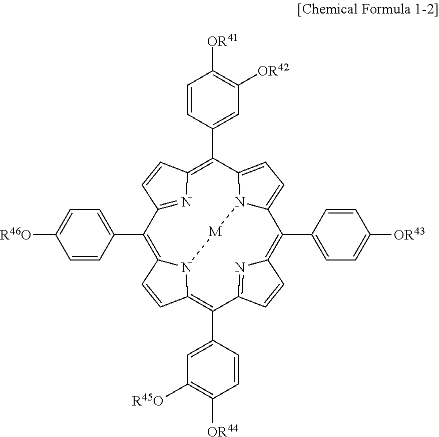

In Chemical Formula 1-2,
R⁴¹ to R⁴⁶ are each independently a hydrogen atom, a substituted or unsubstituted C1 to C20 alkyl group, a substituted or unsubstituted C1 to C20 alkoxy group, *—C(═O)OR (R is a substituted or unsubstituted C1 to C15 alkyl group), a substituted or unsubstituted C3 to C20 cycloalkyl group, or a substituted or unsubstituted C6 to C20 aryl group; and
at least one of R⁴¹ to R⁴⁶ is a C1 to C20 alkyl group having a terminal end substituted with (meth)acrylate.

When the compound of the above embodiment is represented by Chemical Formula 1-1 1-1, at least two of R³¹ to R³⁸ may be a C1 to C10 alkyl group having a terminal end substituted with (meth)acrylate. In addition, among R³¹ to R³⁸, a functional group other than a C1 to C10 alkyl group whose terminal end is substituted with (meth)acrylate may be a C4 to C10 branched alkyl group.

When the compound of the above embodiment is represented by Chemical Formula 1-2, at least two of R⁴¹ to R⁴⁶ may be a C1 to C10 alkyl group having a terminal end substituted with (meth)acrylate. In addition, among R⁴¹ to R⁴⁶, a functional group other than a C1 to C10 alkyl group whose terminal end is substituted with (meth)acrylate may be a C4 to C10 branched alkyl group.

The compound of the above embodiment may be selected from the group including:

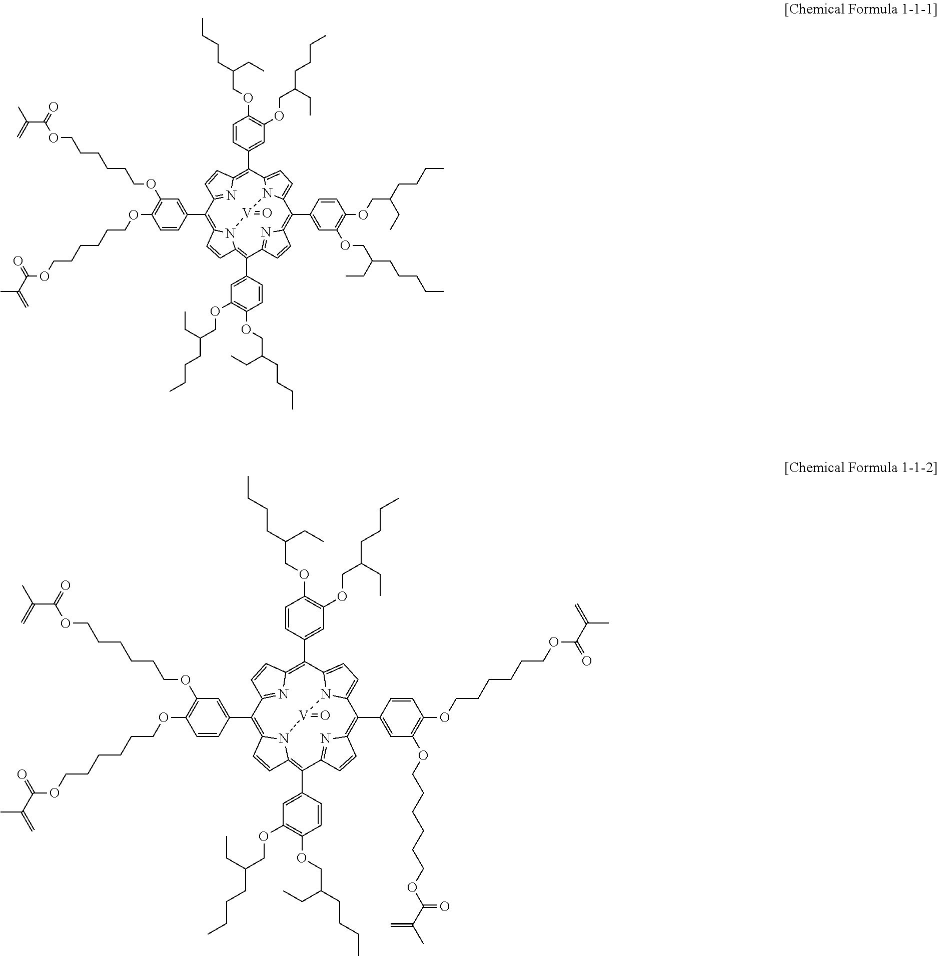

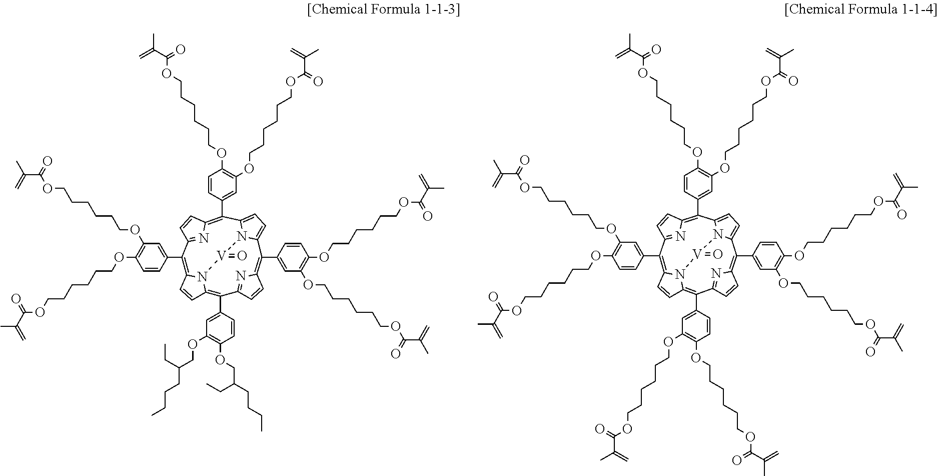

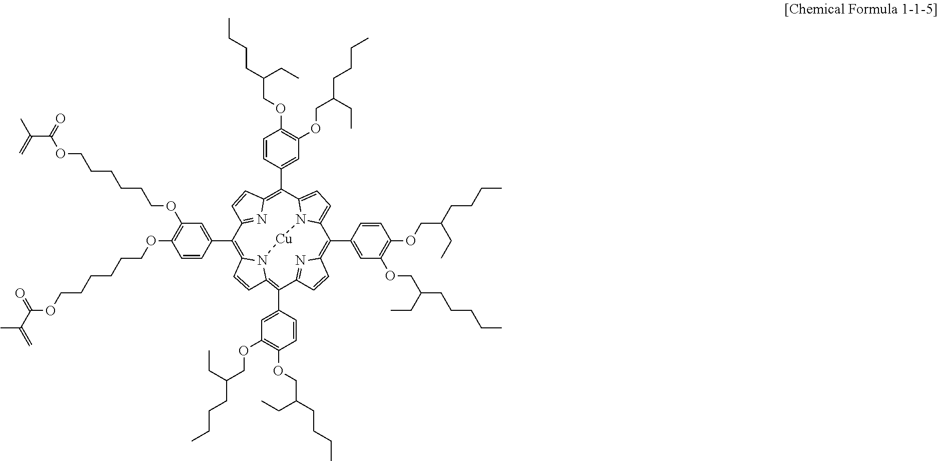

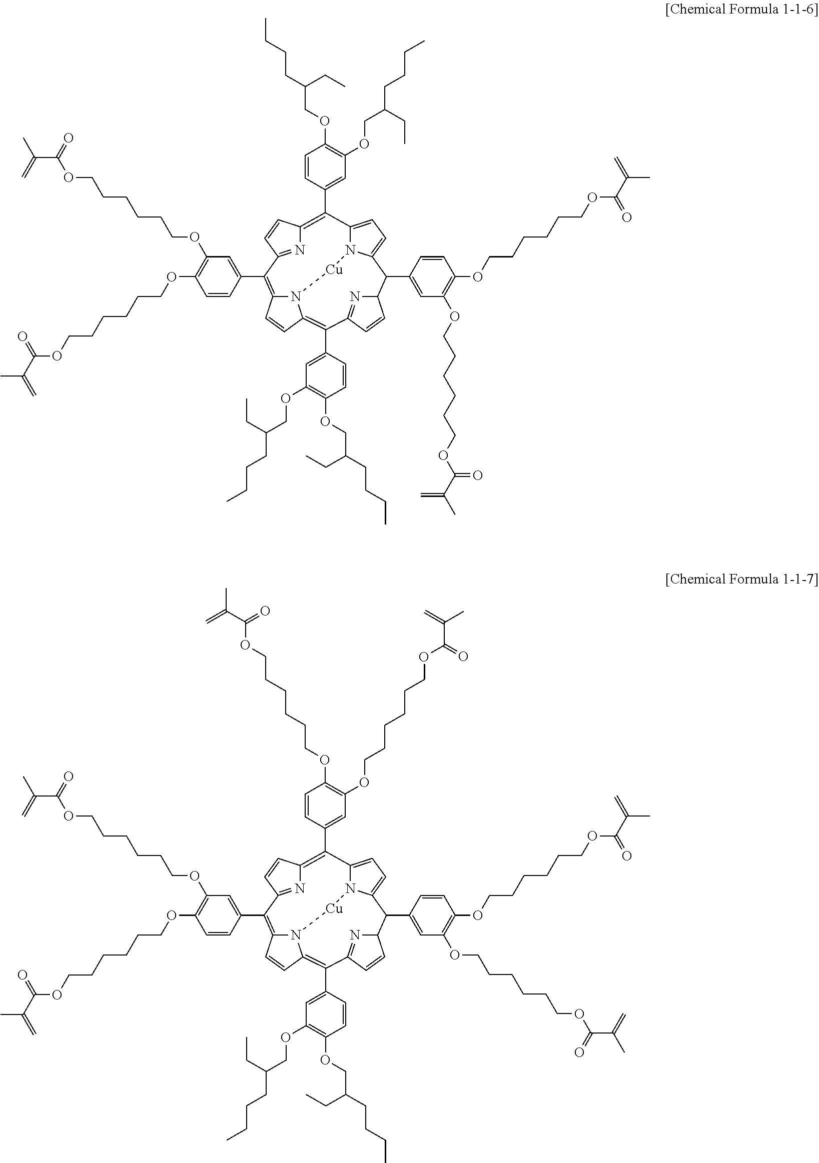

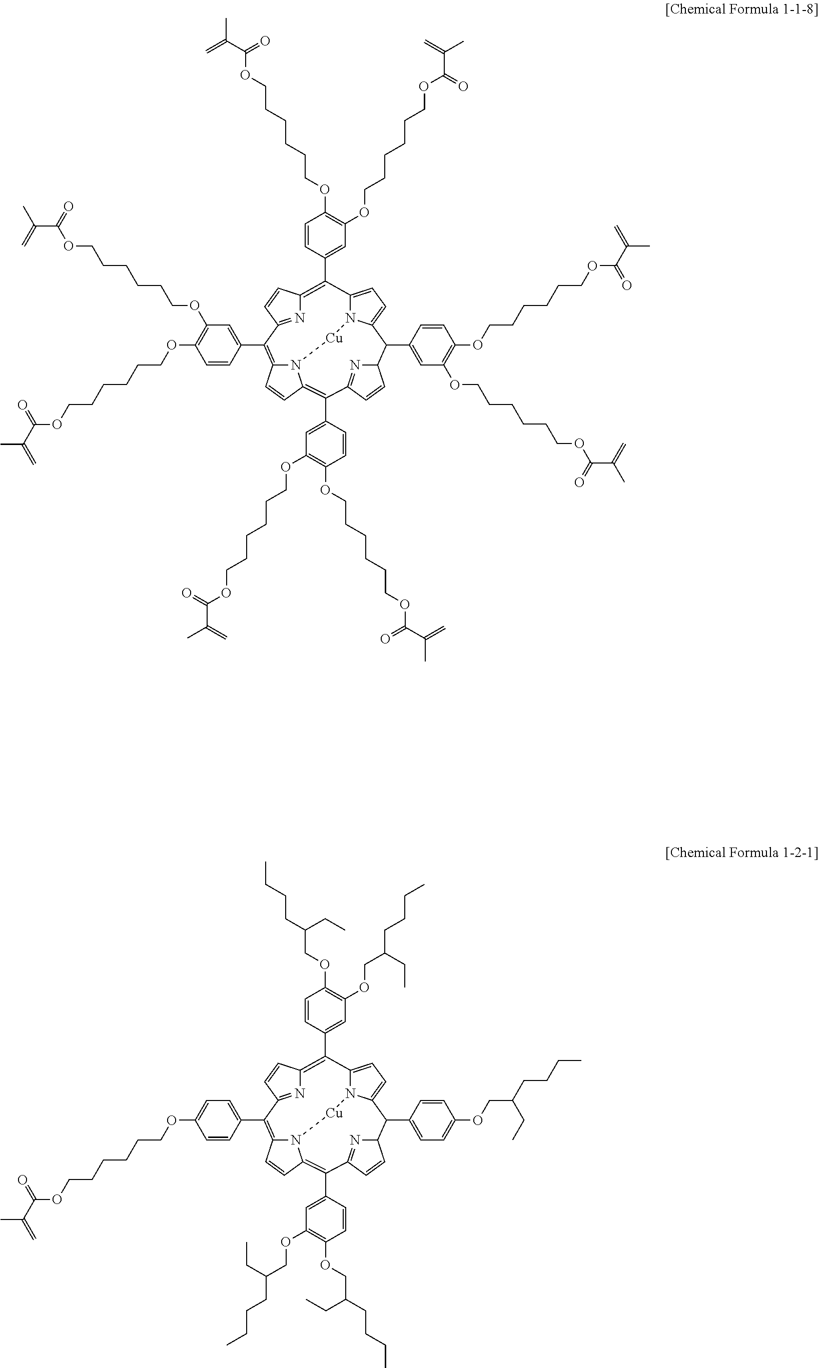

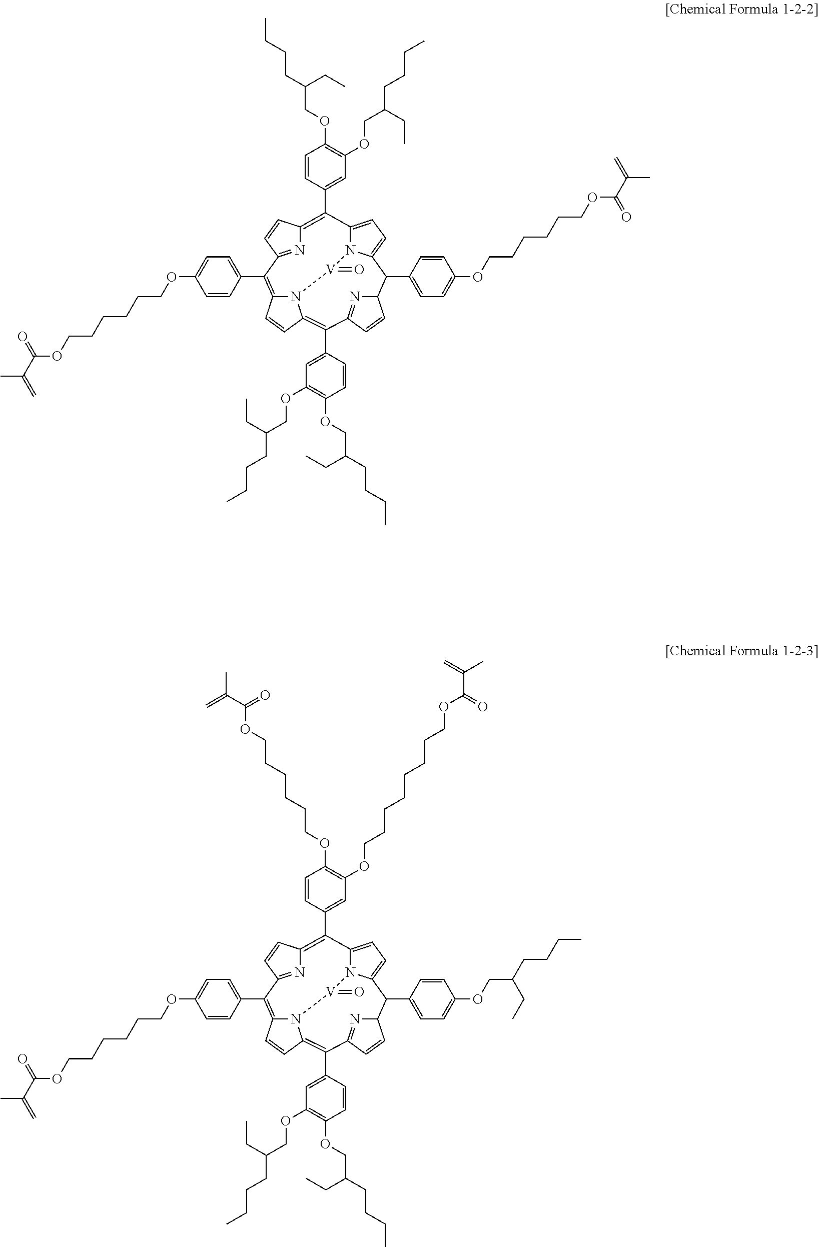

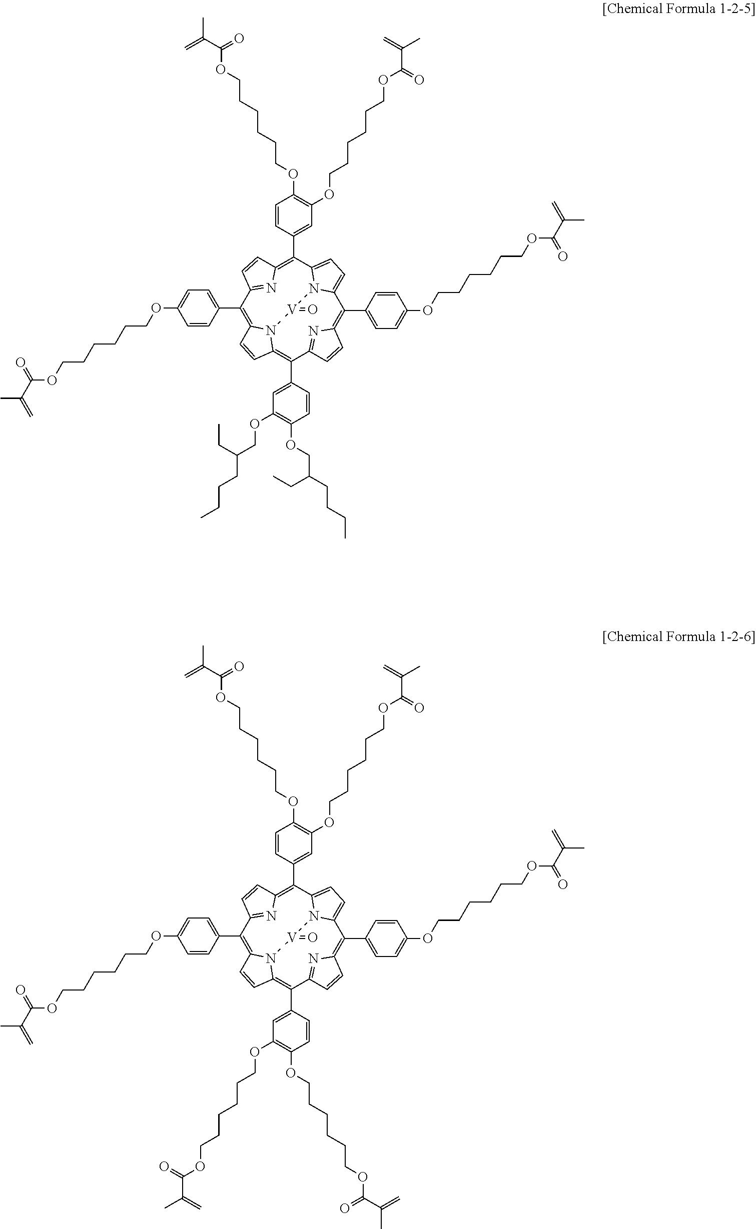

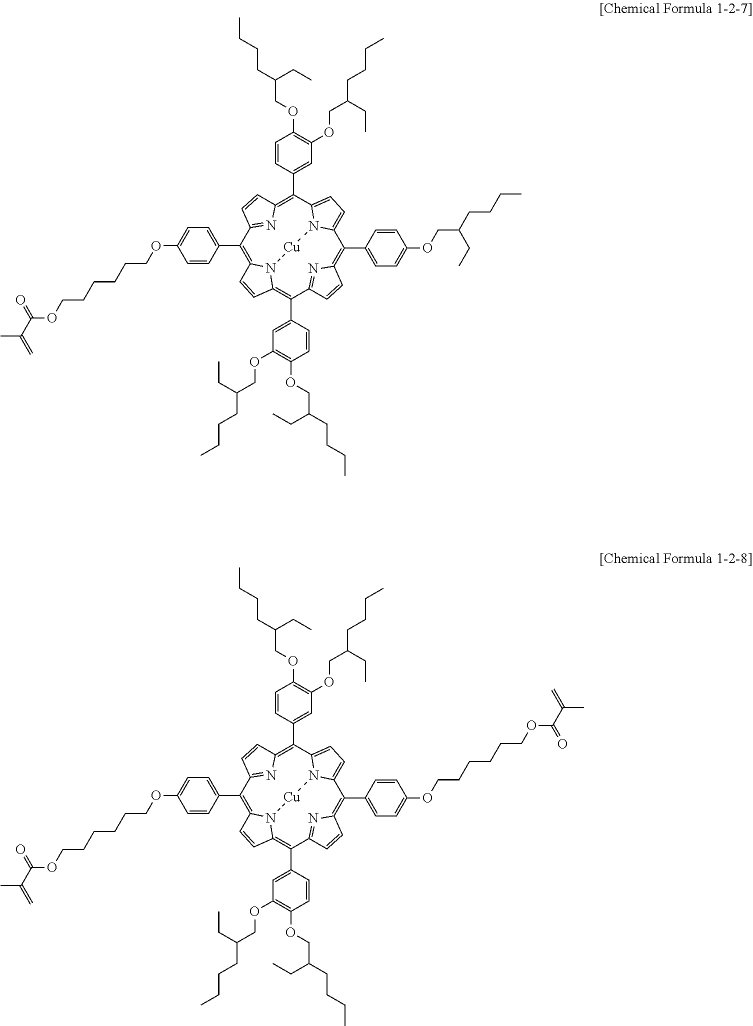

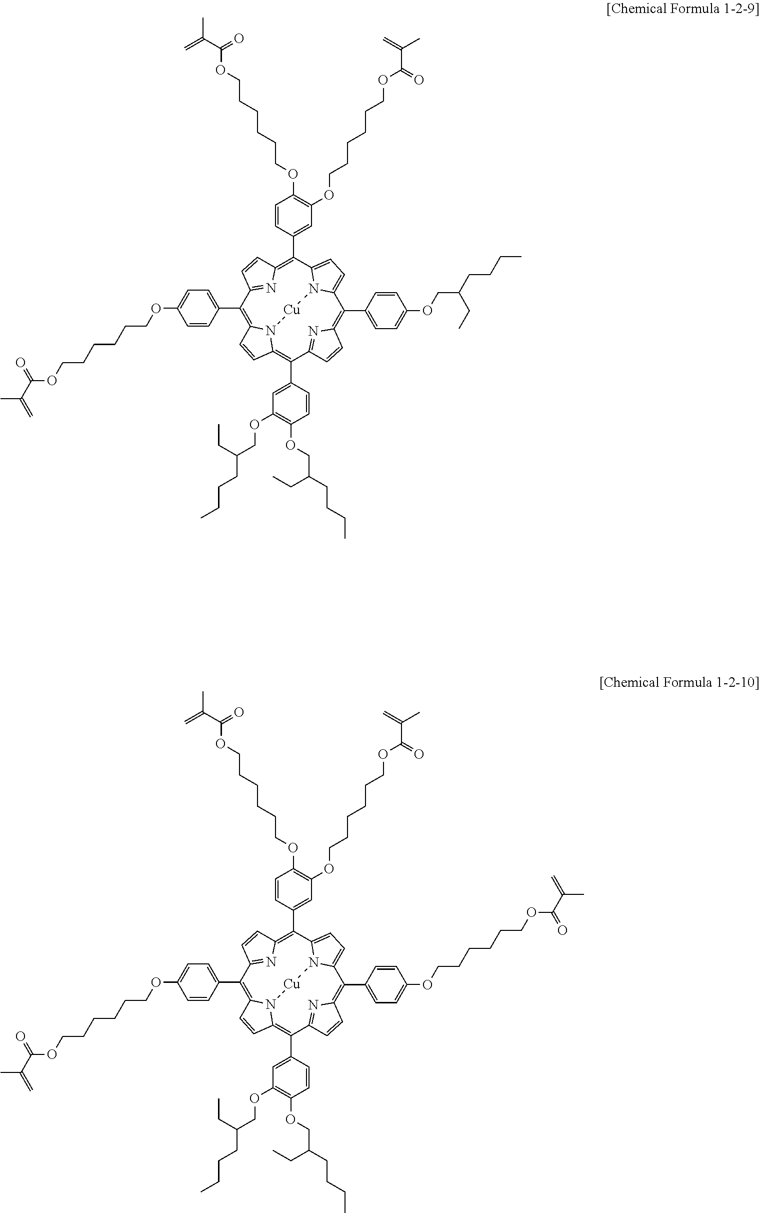

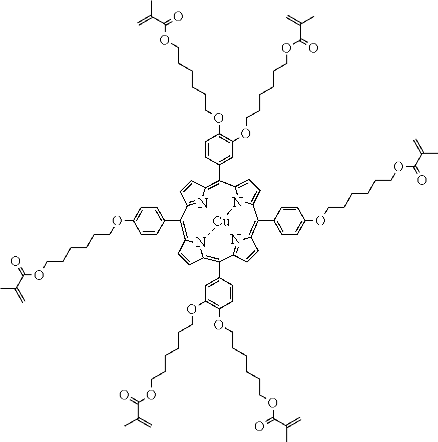

The compound of one embodiment may absorb light at a wavelength of 350 nm to 480 nm and 500 nm to 550 nm, among which a maximum absorption wavelength (λₘₐₓ) may be 425 nm to 440 nm and specifically, 425 nm to 435 nm.

Considering a spectrum of a blue light source, in order to improve color reproducibility of a panel, light of a short wavelength region (about 430 nm or more) of the blue light source is desirable to effectively absorb. In other words, as a maximum absorption wavelength of a dye applied to an antireflection film is closer to 430 nm, the light of the short wavelength region of the blue light source may be effectively absorbed.

The compound of one embodiment may absorb light of a wavelength of 350 nm to 480 nm and 500 nm to 550 nm. In particular, the compound of one embodiment may have a maximum absorption wavelength (λₘₐₓ) shifted toward a long wavelength region, compared with generally known porphyrin-based dyes, and thus ranging from 425 nm to 440 nm and specifically, 425 nm to 435 nm.

Accordingly, the compound of one embodiment may effectively absorb light in the short wavelength region of the blue light source and thereby, effectively improve color reproducibility of a panel as well as secure light resistance reliability. Furthermore, a display device including the compound of one embodiment in an antireflection film may be suppressed from luminance loss and exhibit improved panel color reproducibility.

The compound of one embodiment may be a color material for electronic materials.

Herein, the [symbol] electron materials are not particularly limited but may be materials used in common liquid crystal display devices such as liquid crystal displays (LCD), etc.; light emitting display devices using luminescent materials such as quantum dots, organic inorganic phosphors, etc.; image sensors such as charge coupled devices (CCD) and CMOS (complementary metal-oxide semiconductor) image sensors, etc.; electronic or electrical parts such as prepreg, resin sheets, build-up materials, non-conductive films, metal foil-clad laminates, and printed wiring boards, etc.; and the like.

Specifically, the compound of one embodiment may be a dye applied to an antireflection film for the common liquid crystal display devices, the light emitting display devices, and the like. In particular, the compound of one embodiment is applied to the antireflection film of the light emitting display devices to suppress a luminance loss and improve panel color reproducibility.

Another embodiment provides an antireflection film including the compound.

The antireflection film may include the compound of one embodiment in an amount of 0.001 wt % to 0.5 wt % based on a solid content. Within the range, it is easy to adjust a panel color tone of a display device to which the antireflection film is applied, and the dye may be mixed with another dye having a different absorption region to improve black visibility (neutral black).

The antireflection film includes an adhesive layer and an antireflection layer formed on the adhesive layer, and the compound of one embodiment may be included in the adhesive layer.

In addition, the antireflection film includes an adhesive layer, a dye-containing layer, and an antireflection layer formed on the dye-containing layer, and the compound of an embodiment may be included in the adhesive layer, the dye-containing layer, or both.

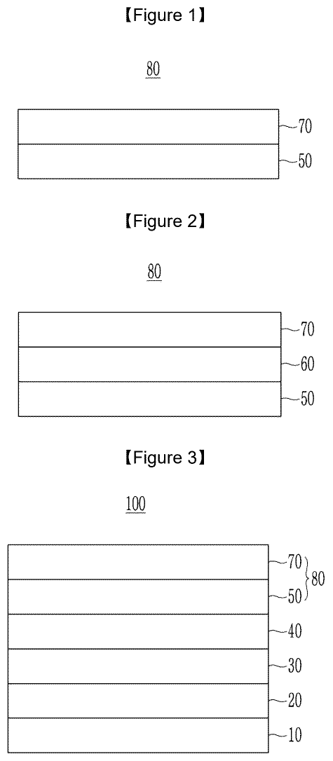

That is, in the stacked structure of the antireflection film according to the above embodiment, the compound of the above embodiment may be included in the adhesive layer or may be included in a separate dye-containing layer. (See FIGS. 1 and 2)

The antireflection layer may consist of only a low refractive layer or may include a low refractive layer.

The low refractive layer may lower a reflectance of the antireflection film due to a difference in refractive index between the substrate and/or the high refractive layer described later.

The low refractive layer may include a curable binder resin, a fluorine atom-containing monomer, and fine particles (e.g., hollow silica) having an average particle diameter of 5 nm to 300 nm, and the thickness of the low refractive layer may be 0.01 μm to 0.15 μm. The refractive index of the low refractive layer may be 1.20 to 1.40.

An additional function may be imparted to the antireflection film by further forming a functional coating layer on one surface of the low refractive layer, that is, on the upper surface of the low refractive layer. The functional coating layer may include an antifingerprint layer, an antistatic layer, a hard coating layer, an antiglare layer, a barrier layer, etc., but is not limited thereto.

The antireflection layer may further include a high refractive layer.

The high refractive layer is formed between the substrate to be described later and the low refractive layer, and has a refractive index between the substrate and the low refractive layer, thereby reducing the reflectance of the antireflection layer. The high refractive layer is formed directly with the substrate and the low refractive layer, respectively. The “directly formed” means that there are no other layers between the layer and the layer.

The high refractive layer has a thickness of 0.05 μm to 20 μm, a refractive index of 1.45 to 2, and a haze value specified in JIS-K7361 is not different from the haze value of the base material or 10% or less of the difference between the haze value of substrate, which is excellent in transparency and is excellent in antireflection properties.

The hard coating layer increases a hardness of the antireflection layer so that even if the antireflection layer is used on the outermost surface of the display device, scratches may not be generated. The hard coating layer is not necessarily provided. The hard coating layer may be omitted if a target hardness is secured in the high or low refractive layer.

The hard coating layer may be formed between the substrate and the high refractive layer or between the substrate and the low refractive layer.

The hard coating layer may be a cured layer formed by uniformly mixing ultrafine metal oxide particles having an average particle diameter of 1 nm to 30 nm and a particle size distribution range of less than or equal to ±5 nm in a cured binder. The hard coating layer may have a thickness of 1 μm to 15 μm, and the refractive index of the hard coating layer may be greater than or equal to 1.54.

The antireflection layer may have a thickness of 50 μm to 500 μm, for example 50 μm to 300 μm, for example 50 μm to 150 μm. When the antireflection layer has a thickness within the above range, it may be easily applied to a display device.

The adhesive layer may be formed on the lower surface of the antireflection layer to adhere an optical member such as a display to a panel or the like. As described above, the adhesive layer may include a compound (dye) represented by Chemical Formula 1.

The adhesive layer may have a glass transition temperature of −70° C. to 0° C., for example −65° C. to −20° C. When the glass transition temperature of the adhesive layer is within the above range, adhesion to the panel may be improved.

The adhesive layer may be a thermosetting adhesive layer or a photocurable adhesive layer. Desirably, since the adhesive layer becomes a thermosetting adhesive layer, it is not necessary to consider the effect of ultraviolet rays due to the absorption wavelength of the compound (dye) represented by Chemical Formula 1, thereby facilitating the manufacture of the adhesive layer. The “thermosetting adhesive layer” may include not only an adhesive layer cured through a predetermined heat treatment at 40° C. to 100° C., but also an adhesive layer cured at room temperature (e.g., 20° C. to 30° C.).

The adhesive layer may be formed of a composition for an adhesive layer including an adhesive resin and a curing agent.

The type of the adhesive resin is not limited as long as it can secure the glass transition temperature of the adhesive layer. For example, the adhesive resin may be a silicone-based, urethane-based, (meth)acrylic resin, or the like, but desirably, a (meth)acrylic adhesive resin may be used.

The adhesive resin may have a glass transition temperature of −70° C. to 0° C., desirably −65° C. to −20° C. When the glass transition temperature of the adhesive resin has the above range, adhesion to the panel may be improved.

The adhesive resin may have a weight average molecular weight of 500,000 g/mol to 2,000,000 g/mol, for example 800,000 g/mol to 1,500,000 g/mol. When the weight average molecular weight of the adhesive resin has the above range, adhesion to the panel may be improved.

The adhesive resin may include a copolymer, desirably a random copolymer of at least one of a (meth)acrylic monomer having an alkyl group; a (meth)acrylic monomer having a hydroxyl group; and a (meth)acrylic monomer having an aromatic group, a (meth)acrylic monomer having an alicyclic group, and a (meth)acrylic monomer having a heteroalicyclic group.

The (meth)acrylic monomer having the alkyl group may include a (meth)acrylic acid ester having an unsubstituted C1 to C10 alkyl group. Specifically, the (meth)acrylic monomer having the alkyl group may include one or more of methyl (meth)acrylate, ethyl (meth)acrylate, propyl (meth)acrylate, n-butyl (meth)acrylate, t-butyl (meth)acrylate, iso-butyl (meth)acrylate, pentyl (meth)acrylate, hexyl (meth)acrylate, 2-ethylhexyl (meth)acrylate, heptyl (meth)acrylate, octyl (meth)acrylate, iso-octyl (meth)acrylate, nonyl (meth)acrylate, and decyl (meth)acrylate, but is not limited thereto. These may be included alone or in combination of two or more. The (meth)acrylic monomer having the alkyl group may be included in an amount of 60 wt % to 99.99 wt %, for example 60 wt % to 90 wt %, for example 80 wt % to 99.9 wt % of the monomer mixture.

The (meth)acrylic monomer having the hydroxyl group may include one or more of a (meth)acrylic monomer having a C1 to C20 alkyl group having at least one hydroxyl group, a (meth)acrylic monomer having a C3 to C20 cycloalkyl group having at least one hydroxyl group, and a (meth)acrylic monomer having a C6 to C20 aromatic group having at least one hydroxyl group. Specifically, the (meth)acrylic monomer having the hydroxyl group may include desirably a (meth)acrylic monomer having a C1 to C20 alkyl group having at least one hydroxyl group, one or more of 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, 1-chloro-2-hydroxypropyl(meth)acrylate. These may be included alone or in combination of two or more. The (meth)acrylic monomer having the hydroxyl group may be included in an amount of 0.01 wt % to 20 wt %, for example 0.1 wt % to 10 wt % of the monomer mixture.

The (meth)acrylic monomer having the aromatic group may include a (meth)acrylic acid ester having a C6 to C20 aryl group or a C7 to C20 arylalkyl group. Specifically, the (meth)acrylic monomer having the aromatic group may include, but is not limited to, phenyl (meth)acrylate, benzyl (meth)acrylate, and the like. The (meth)acrylic monomer having the aromatic group may be included in an amount of 0 wt % to 50 wt %, for example 0 wt % to 20 wt % of the monomer mixture.

In the present specification, when an alicyclic group and an alkyl group are mixed among the monomers, it is classified as a (meth)acrylic monomer having an alicyclic group.

The (meth)acrylic monomer having the alicyclic group may be a (meth)acrylic acid ester having a C5 to C20 monocyclic or heterocyclic alicyclic group and may include at least one of cyclohexyl(meth)acrylate, isobornyl(meth)acrylate, dicyclopentanyl(meth)acrylate, methylcyclohexyl(meth)acrylate, and dicyclopentenyl (meth)acrylate. The (meth)acrylic monomer having the alicyclic group may be included in an amount of 0 wt % to 50 wt %, for example 1 wt % to 30 wt %, or 1 wt % to 20 wt % of the monomer mixture.

The (meth)acrylic monomer having the heteroalicyclic group may include a (meth)acrylic acid ester having a C4 to C9 heteroalicyclic group including at least one of nitrogen, oxygen, or sulfur. Specifically, the (meth)acrylic monomer having the heteroalicyclic group may include (meth)acryloylmorpholine, but is not limited thereto. The (meth)acrylic monomer having the heteroalicyclic group may be included in an amount of 0 wt % to 50 wt %, for example 0 wt % to 10 wt % of the monomer mixture.

The adhesive resin may include a (meth)acrylic copolymer of a monomer mixture including 70 wt % to 99.99 wt %, for example 90 wt % to 99.5 wt % of the (meth)acrylic monomer having the alkyl group, 0.01 wt % to 30 wt %, for example 0.5 wt % to 10 wt % of the (meth)acrylic monomer having the hydroxyl group. When each of the monomers constituting the adhesive resin has the above ranges, adhesive strength may be easily secured.

The curing agent may include an isocyanate-based curing agent. The curing agent may be included in an amount of 0.01 parts by weight to 20 parts by weight, for example 0.01 parts by weight to 10 parts by weight, for example 0.1 parts by weight to 4 parts by weight, based on 100 parts by weight of the adhesive resin. When the curing agent has the above range, the composition may be crosslinked to form an adhesive layer and to prevent a decrease in transparency and poor reliability due to its excessive use.

The composition may further include conventional additives such as a silane coupling agent, an antioxidant, a tackifying resin, a plasticizer, an antistatic agent, a rework agent, and a curing catalyst. The silane coupling agent may be included in an amount of 0.01 parts by weight to 20 parts by weight, for example 0.01 parts by weight to 10 parts by weight, for example 0.1 parts by weight to 4 parts by weight, based on 100 parts by weight of the adhesive resin. When the silane coupling agent has the above range, adhesion may be controlled and reliability defects may be prevented.

The composition for the adhesive layer may be a solvent-free type or may further include a conventional organic solvent to increase coating properties.

The adhesive layer may have a thickness of 1 μm to 50 μm, for example, 5 μm to 25 μm. When the adhesive layer has a thickness within the above range, it may be easily used in a display device.

According to another embodiment, a display device including the antireflection film is provided. For example, a display device including the antireflection film and the quantum dot-containing layer may be provided.

For example, the display device may further include a light source, a color filter, and a substrate.

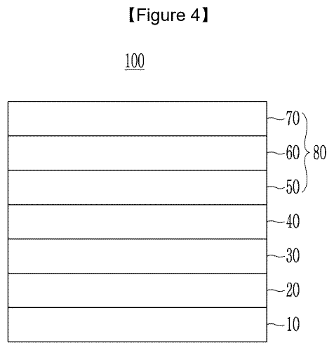

For example, the display device may have a stacked structure in which the quantum dot-containing layer may be disposed on the light source, the color filter may be disposed on the quantum dot-containing layer, the substrate may be disposed on the color filter, and the antireflection film may be disposed on the substrate. (See FIGS. 3 and 4)

For example, the light source may be a blue light source.

For example, the substrate may be a glass substrate.

Components constituting the quantum dot-containing layer may further include a binder resin, a reactive unsaturated compound, a photopolymerization initiator, a diffusion agent, and other additives, which will be described later, in addition to the quantum dot.

The quantum dot may have a full width at half maximum (FWHM) in a range of 20 nm to 100 nm, for example, 20 nm to 50 nm. When the quantum dot has a full width at half maximum (FWHM) within the range, the quantum dot has high color purity and thus an effect on increasing color reproducibility when used as a color material in a color filter.

The quantum dot may be an organic material, an inorganic material, or a hybrid (mixture) of the organic material and the inorganic material.

The quantum dot may each independently include a core and a shell surrounding the core, and herein, the core and the shell may have a structure such as a core each independently including Group II-IV, Group III-V, and the like, a core/a shell, a core/a first shell/a second shell, an alloy, an alloy/a shell, and the like, but are not limited thereto.

For example, the core may include at least one material selected from CdS, CdSe, CdTe, ZnS, ZnSe, ZnTe, HgS, HgSe, HgTe, GaN, GaP, GaAs, InP, InAs, and an alloy thereof, but is not necessarily limited thereto. The shell surrounding the core may include at least one material selected from CdSe, ZnSe, ZnS, ZnTe, CdTe, PbS, TiO, SrSe, HgSe, and an alloy thereof but is not necessarily limited thereto.

In an embodiment, since an interest in an environment has been recently much increased over the whole world, and a regulation about a toxic material also has been fortified, a cadmium-free light emitting material (InP/ZnS) having little low quantum efficiency (quantum yield) but being environmentally-friendly instead of a light emitting material having a cadmium-based core is used but not necessarily limited thereto.

The quantum dot having a core/shell structure may have an entire size (an average particle diameter) including the shell of 1 nm to 15 nm, for example, 5 nm to 15 nm, but its structure is not particularly limited.

For example, the quantum dot may be a red quantum dot, a green quantum dot, or a combination thereof For example, the quantum dot may include both green quantum dot and red quantum dot. In this case, the green quantum dots may be included in an amount greater than that of the red quantum dots. The red quantum dot may have an average particle diameter of 10 nm to 15 nm. The green quantum dot may have an average particle diameter of 5 nm to 8 nm.

Meanwhile, for the dispersion stability of the quantum dots, a dispersant may be used together. The dispersant may help a photoconversion material such as the quantum dot uniformly dispersed in the curable composition and include a non-ionic, anionic, or cationic dispersant. Specifically, the dispersant may include polyalkylene glycol or esters thereof, polyoxyalkylene, polyhydric alcohol ester alkylene oxide addition products, alcohol alkylene oxide addition products, sulfonate esters, sulfonate salts, carboxylate esters, carboxylate salts, alkyl amide alkylene oxide addition products, alkyl amines. They may be used alone or as a mixture of two or more. The dispersant may be used in an amount of 0.1 wt % to 100 wt %, for example, 10 wt % to 20 wt % based on the solid content of the photoconversion material such as the quantum dots.

The quantum dots may be included in an amount of 1 to 40 parts by weight, for example, 1 to 10 parts by weight, based on 100 parts by weight of the components constituting the quantum dot-containing layer. When the quantum dot is included within the above range, the light conversion rate is improved and the pattern characteristics and development characteristics are not impaired, so that excellent processibility may be obtained.

The binder resin may include an acrylic resin, an epoxy resin, or a combination thereof.

The acrylic resin is a copolymer of a first ethylenic unsaturated monomer and a second ethylenic unsaturated monomer that is copolymerizable therewith, and is a resin including at least one acrylic repeating unit.

The first ethylenic unsaturated monomer is an ethylenic unsaturated monomer including at least one carboxyl group. Examples of the monomer include acrylic acid, methacrylic acid, maleic acid, itaconic acid, fumaric acid, or a combination thereof.

The first ethylenic unsaturated monomer may be included in an amount of 5 wt % to 50 wt %, for example, 10 wt % to 40 wt % based on the total amount of the acrylic binder resin.

The second ethylenic unsaturated monomer may be an aromatic vinyl compound such as styrene, a-methylstyrene, vinyl toluene, vinylbenzylmethylether, and the like; an unsaturated carboxylate ester compound such as methyl(meth)acrylate, ethyl(meth)acrylate, butyl(meth)acrylate, 2-hydroxyethyl(meth)acrylate, 2-hydroxy butyl(meth)acrylate, benzyl(meth)acrylate, cyclohexyl(meth)acrylate, phenyl(meth)acrylate, and the like; an unsaturated carboxylic acid amino alkyl ester compound such as 2-aminoethyl(meth)acrylate, 2-dimethylaminoethyl(meth)acrylate, and the like; a carboxylic acid vinyl ester compound such as vinyl acetate, vinyl benzoate, and the like; a unsaturated carboxylic acid glycidyl ester compound such as glycidyl(meth)acrylate, and the like; a vinyl cyanide compound such as (meth)acrylonitrile, and the like; a unsaturated amide compound such as (meth)acrylamide, and the like; and the like. These may be used alone or as a mixture of two or more.

Specific examples of the acrylic resin may be polybenzylmethacrylate, a (meth)acrylic acid/benzylmethacrylate copolymer, a (meth)acrylic acid/benzylmethacrylate/styrene copolymer, a (meth)acrylic acid/benzylmethacrylate/2-hydroxyethylmethacrylate copolymer, a (meth)acrylic acid/benzylmethacrylate/styrene/2-hydroxyethylmethacrylate copolymer, and the like, but are not limited thereto. These may be used alone or as a mixture of two or more.

The acrylic resin may have a weight average molecular weight of 1,000 g/mol to 15,000 g/mol. When the acrylic resin has a weight average molecular weight within the range, close-contacting properties to a substrate, and physical and chemical properties are improved and viscosity is appropriate.

The epoxy resin may be a thermally polymerizable monomer or oligomer, and may include a compound having a carbon-carbon unsaturated bond and a carbon-carbon cyclic bond.

The epoxy resin may further include a bisphenol A epoxy resin, a bisphenol F epoxy resin, a phenol novolac epoxy resin, a cyclic aliphatic epoxy resin, and an aliphatic polyglycidyl ether, but is not necessarily limited thereto.

Commercially available products of the compounds may be YX4000, YX4000H, YL6121H, YL6640, or YL6677 of Yuka Shell Epoxy Co., Ltd.; EOCN-102, EOCN-103S, EOCN-104S, EOCN-1020, EOCN-1025, or EOCN-1027 of Nippon Kayaku Co. Ltd. and EPIKOTE 180S75 of Yuka Shell Epoxy Co., Ltd.; a bisphenol A epoxy resin such as EPIKOTE 1001, 1002, 1003, 1004, 1007, 1009, 1010 and 828 of Yuka Shell Epoxy Co., Ltd.; a bisphenol F epoxy resin such as EPIKOTE 807 and 834 of Yuka Shell Epoxy Co., Ltd.; a phenol novolac epoxy resin such as EPIKOTE 152, 154, or 157H65 of Yuka Shell Epoxy Co., Ltd. and EPPN 201, 202 of Nippon Kayaku Co. Ltd.; a cyclic aliphatic epoxy resin such as CY175, CY177, and CY179 of CIBA-GEIGY A.G Corp., ERL-4234, ERL-4299, ERL-4221 and ERL-4206 of U.C.C., Showdyne 509 of Showa Denko K.K., Araldite CY-182 of CIBA-GEIGY A.G Corp., CY-192 and CY-184, Dainippon Ink & Chemicals Inc., EPICLON 200 and 400, EPIKOTE 871, 872 of Yuka Shell Epoxy Co. and EP1032H60, ED-5661, and ED-5662 of Celanese Coating Corporation; an aliphatic polyglycidylether may be EPIKOTE 190P and 191P of Yuka Shell Epoxy Co., EPOLITE 100MF of Kyoeisha Yushi Kagaku Kogyo Co., Ltd., EPIOL TMP of Nihon Yushi K. K., and the like.

The binder resin may be included in an amount of 1 to 40 parts by weight, for example, 5 to 20 parts by weight, based on 100 parts by weight of the components constituting the quantum dot-containing layer. When the binder resin is included within the above range, excellent sensitivity, developability, resolution, and linearity of the pattern may be obtained.

The reactive unsaturated compound may be used by mixing monomers or oligomers generally used in conventional photocurable compositions and thermosetting compositions.

The reactive unsaturated compound may be an acrylate-based compound. For example, at least one of ethylene glycoldiacrylate, triethylene glycoldiacrylate, 1,4-butanedioldiacrylate, 1,6-hexanedioldiacrylate, neopentylglycoldiacrylate, pentaerythritoldiacrylate, pentaerythritoltriacrylate, dipentaerythritoldiacrylate, dipentaerythritoltriacrylate, dipentaerythritolpentaacrylate, pentaerythritolhexaacrylate, bisphenol A diacrylate, trimethylolpropanetriacrylate, novolacepoxyacrylate, ethylene glycoldimethacrylate, diethylene glycoldimethacrylate, triethylene glycoldimethacrylate, propylene glycoldimethacrylate, 1,4-butanedioldimethacrylate, 1,6-hexanedioldimethacrylate or a mixture thereof may be used.

The reactive unsaturated compound may be treated with acid anhydride to improve developability.

The reactive unsaturated compound may be included in an amount of 1 to 10 parts by weight, for example, 1 to 5 parts by weight, based on 100 parts by weight of the component constituting the quantum dot-containing layer. When the reactive unsaturated compound is included within the above range, curing occurs sufficiently during exposure in the pattern formation process, resulting in excellent reliability, heat resistance, light resistance, chemical resistance, resolution, and close-contacting properties of the pattern.

The photopolymerization initiator may be an acetophenone-based compound, a benzophenone-based compound, a thioxanthone-based compound, a benzoin-based compound, an oxime-based compound, and the like.

Examples of the acetophenone-based compound may be 2,2′-diethoxy acetophenone, 2,2′-dibutoxy acetophenone, 2-hydroxy-2-methylpropinophenone, p-t-butyltrichloro acetophenone, p-t-butyldichloro acetophenone, 4-chloro acetophenone, 2,2′-dichloro-4-phenoxy acetophenone, 2-methyl-1-(4-(methylthio)phenyl)-2-morpholinopropan-1-one, 2-benzyl-2-dimethylamino-1-(4-morpholinophenyl)-butan-1-one, and the like.

Examples of the benzophenone-based compound may be benzophenone, benzoyl benzoate, benzoyl methyl benzoate, 4-phenyl benzophenone, hydroxybenzophenone, acrylated benzophenone, 4,4′-bis(dimethyl amino)benzophenone, 4,4′-bis(diethylamino)benzophenone, 4,4′-dimethylaminobenzophenone, 4,4′-dichlorobenzophenone, 3,3′-dimethyl-2-methoxybenzophenone, and the like.

Examples of the thioxanthone-based compound may be thioxanthone, 2-methylthioxanthone, isopropyl thioxanthone, 2,4-diethyl thioxanthone, 2,4-diisopropyl thioxanthone, 2-chlorothioxanthone, and the like.

Examples of the benzoin-based compound may be benzoin, benzoin methyl ether, benzoin ethyl ether, benzoin isopropyl ether, benzoin isobutyl ether, benzyldimethylketal, and the like.

Examples of the triazine-based compound may be 2,4,6-trichloro-s-triazine, 2-phenyl-4,6-bis(trichloromethyl)-s-triazine, 2-(3′,4′-dimethoxystyryl)-4,6-bis(trichloromethyl)-s-triazine, 2-(4′-methoxynaphthyl)-4,6-bis(trichloromethyl)-s-triazine, 2-(p-methoxyphenyl)-4,6-bis(trichloromethyl)-s-triazine, 2-(p-tolyl)-4,6-bis(trichloromethyl)-s-triazine, 2-biphenyl-4,6-bis(trichloromethyl)-s-triazine, bis(trichloromethyl)-6-styryl-s-triazine, 2-(naphtho-1-yl)-4,6-bis(trichloromethyl)-s-triazine,2-(4-methoxynaphtho-1-yl)-4,6-bis(trichloromethyl)-s-triazine, 2-4-bis(trichloromethyl)-6-piperonyl-s-triazine, 2-4-bis(trichloromethyl)-6-(4-methoxystyryl)-s-triazine, and the like.

Examples of the oxime-based compound may be O-acyloxime-based compound, 2-(O-benzoyloxime)-1-[4-(phenylthio)phenyl]-1,2-octanedione, 1-(0-acetyloxime)-1-[9-ethyl-6-(2-methylbenzoyl)-9H-carbazol-3-yl]ethanone, O-ethoxycarbonyl-a-oxyamino-1-phenylpropan-1-one, and the like. Specific examples of the O-acyloxime-based compound may be 1,2-octanedione, 2-dimethylamino-2-(4-methylbenzyl)-1-(4-morpholin-4-yl-phenyl)-butan-1-one, 1-(4-phenylsulfanyl phenyl)-butane-1,2-dione-2-oxime-O-benzoate, 1-(4-phenylsulfanyl phenyl)-octane-1,2-dione-2-oxime-O-benzoate, 1-(4-phenylsulfanyl phenyl)-octan-1-oneoxime-O-acetate, 1-(4-phenylsulfanyl phenyl)-butan-1-oneoxime-O-acetate, and the like.

The photopolymerization initiator may further include a carbazole-based compound, a diketone-based compound, a sulfonium borate-based compound, a diazo-based compound, an imidazole-based compound, a biimidazole-based compound, a fluorene-based compound, and the like, besides the compounds.

The photopolymerization initiator may be used with a photosensitizer capable of causing a chemical reaction by absorbing light and becoming excited and then, transferring its energy.

Examples of the photosensitizer may be tetraethylene glycol bis-3-mercapto propionate, pentaerythritol tetrakis-3-mercapto propionate, dipentaerythritol tetrakis-3-mercapto propionate, and the like.

The photopolymerization initiator may be included in an amount of 0.1 parts by weight to 10 parts by weight, for example, 0.1 parts by weight to 5 parts by weight, based on 100 parts by weight of the components constituting the quantum dot-containing layer. When the photopolymerization initiator is included within the above range, a balance between sensitivity and developability during exposure is improved, so that a pattern having excellent resolution without residual film may be obtained.

The quantum dot-containing layer may further include a diffusion agent.

For example, the diffusion agent may include barium sulfate (BaSO₄), calcium carbonate (CaCO₃), titanium dioxide (TiO₂), zirconia (ZrO₂), or a combination thereof.

The diffusion agent reflects light not absorbed in the aforementioned quantum dot, so that the reflected light may be adsorbed again in the quantum dot. In other words, the diffusion agent increases an amount of the light absorbed in the quantum dot and thus light conversion efficiency of the curable composition.

The diffusion agent may have an average particle diameter (D₅₀) within a range of 150 nm to 250 nm and specifically, 180 nm to 230 nm. When the diffusion agent has an average particle diameter within the range, much more excellent light scattering effects may be obtained, and light conversion efficiency may be increased.

The diffusion agent may be included in an amount of 0.1 wt % to 20 wt %, for example 0.1 wt % to 5 wt %, based on the solid content of 100 parts by weight of components constituting the quantum dot-containing layer. When the diffusion agent is included in an amount of less than 0.1 wt % based on 100 parts by weight of components constituting the quantum dot-containing layer, it is difficult to expect the effect of improving the light conversion efficiency by using the diffusion agent, while when the diffusion agent is included in an amount of greater than 5 wt %, pattern characteristics of may be deteriorated.

In order to improve the stability and dispersibility of the quantum dots, the quantum dot-containing layer may further include a thiol-based additive.

The thiol-based additive may replace the shell surface of the quantum dot, and may improve dispersion stability of a quantum dot in a solvent and may stabilize the quantum dot.

The thiol-based additive may have one or more, for example, 2 to 10, for example 2 to 4 thiol groups (—SH) at the terminal end according to its structure.

For example, the thiol-based additive may include at least two functional groups represented by Chemical Formula 2

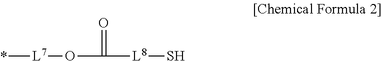

In Chemical Formula 2,
L⁷ and L⁸ are each independently a single bond, a substituted or unsubstituted C1 to C20 alkylene group, a substituted or unsubstituted C3 to C20 cycloalkylene group, a substituted or unsubstituted C6 to C20 arylene group, or a substituted or unsubstituted C2 to C20 heteroarylene group.

For example, the thiol-based additive may be represented by Chemical Formula 3.

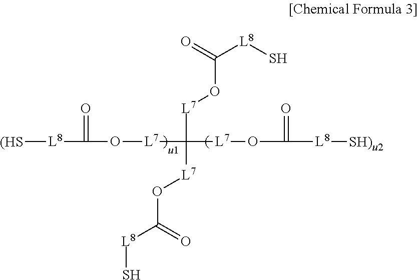

In Chemical Formula 3,
L⁷ and L⁸ are each independently a single bond, a substituted or unsubstituted C1 to C20 alkylene group, a substituted or unsubstituted C3 to C20 cycloalkylene group, a substituted or unsubstituted C6 to C20 arylene group, or a substituted or unsubstituted C2 to C20 heteroarylene group, and
u1 and u2 are each independently an integer of 0 or 1.

For example, in Chemical Formula 2 and Chemical Formula 3, L⁷ and L⁸ may each independently be a single bond or a substituted or unsubstituted C1 to C20 alkylene group.

Specific examples of the thiol-based additive may be selected from pentaerythritol tetrakis(3-mercaptopropionate) represented by Chemical Formula 2a, trimethylolpropane tris(3-mercaptopropionate) represented by Chemical Formula 2b, pentaerythritol tetrakis(mercaptoacetate) represented by Chemical Formula 2c, trimethylolpropane tris(2-mercaptoacetate) represented by Chemical Formula 2d, glycol di-3-mercaptopropionate represented by Chemical Formula 2e, and a combination thereof.

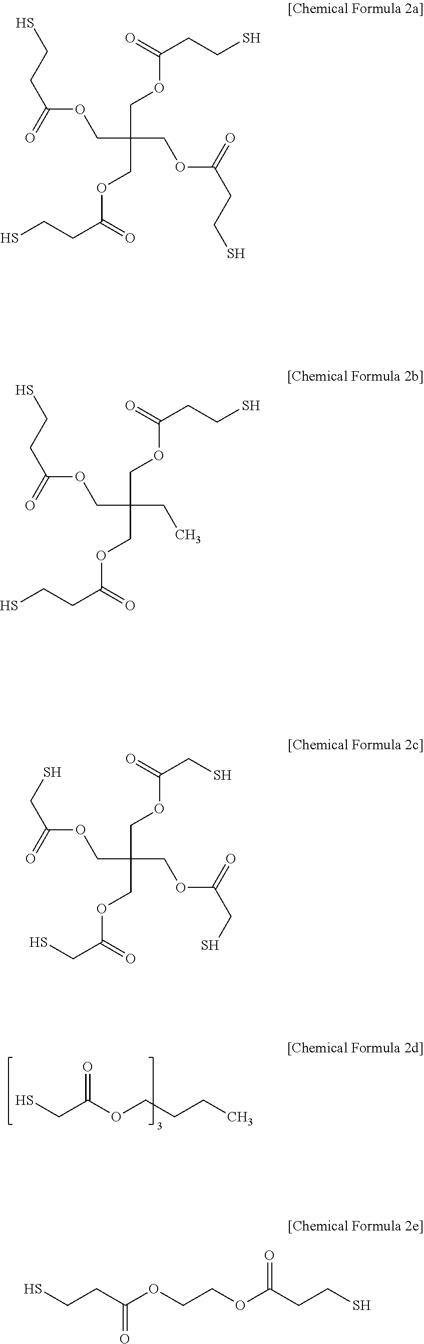

The thiol-based additive may be included in an amount of 0.1 parts by weight to 10 parts by weight, for example 0.1 parts by weight to 5 parts by weight based on 100 parts by weight of components constituting the quantum dot-containing layer. When the thiol-based additive is included within the ranges, stability of a photoconversion material such as a quantum dot may be improved, the thiol group in the component reacts with an acrylic group of a resin or a monomer to form a covalent bond and thereby heat resistance of a photoconversion material such as a quantum dot may be improved.

The quantum dot-containing layer may further include a polymerization inhibitor including a hydroquinone-based compound, a catechol-based compound, or a combination thereof. As the quantum dot-containing layer further includes the hydroquinone-based compound, catechol-based compound, or combination thereof, after printing (coating) a composition including quantum dots, crosslinking at room temperature may be prevented during exposure.

For example, the hydroquinone-based compound, catechol-based compound, or combination thereof may include hydroquinone, methyl hydroquinone, methoxyhydroquinone, t-butyl hydroquinone, 2,5-di-t-butyl hydroquinone, 2,5-bis(1,1-dimethylbutyl) hydroquinone, 2,5-bis(1,1,3,3-tetramethylbutyl) hydroquinone, catechol, t-butyl catechol, 4-methoxyphenol, pyrogallol, 2,6-di-t-butyl-4-methylphenol, 2-naphthol, tris(N-hydroxy-N-nitrosophenylaminato-O,O′) aluminium, or a combination thereof, but is not necessarily limited thereto.

The hydroquinone-based compound, catechol-based compound, or combination thereof may be used in the form of a dispersion, and the polymerization inhibitor in the dispersion form may be included in an amount of 0.001 parts by weight to 1 part by weight, for example 0.01 parts by weight to 0.1 parts by weight, based on 100 weight of components constituting a layer including a quantum dot and a fluorescent dye or a quantum dot-containing layer (including no fluorescent dye). When the stabilizer is included within the above range, the problem with aging at room temperature may be solved and sensitivity reduction and surface peeling may be prevented.

The quantum dot-containing layer may include malonic acid; 3-amino-1,2-propanediol; a silane-based coupling agent; a leveling agent; a fluorine-based surfactant; or combination thereof in addition to the thiol-based additive and polymerization inhibitor.

In addition, the quantum dot-containing layer may further include a silane coupling agent having a reactive substituent such as a carboxyl group, a methacryloyl group, an isocyanate group, an epoxy group, and the like to improve its close-contacting properties to a substrate.

Examples of the silane-based coupling agent may include trimethoxysilyl benzoic acid, γ-methacryl oxypropyl trimethoxysilane, vinyl triacetoxysilane, vinyl trimethoxysilane, γ-isocyanate propyl triethoxysilane, γ-glycidoxy propyl trimethoxysilane, 3-(3,4-epoxycyclohexyl)ethyltrimethoxysilane, and the like. These may be used alone or in a mixture of two or more.

The silane-coupling agent may be included in an amount of 0.01 parts by weight to 10 parts by weight based on 100 parts by weight of components constituting the quantum dot-containing layer. When the silane-coupling agent is included within the range, close-contacting property, storing property, and the like may be improved.

In addition, the quantum dot-containing layer may further include a surfactant, for example a fluorine-based surfactant to improve coating and prevent a defect if necessary.

Examples of the fluorine-based surfactant may be BM-1000© and BM-1100© of BM Chemie Inc.; MEGAFACE F 142D©, F 172©, F 173®, and F 183© of Dainippon Ink Kagaku Kogyo Co., Ltd.; FULORAD FC-135©, FULORAD FC-170C®, FULORAD FC-430©, and FULORAD FC-431® of Sumitomo 3M Co., Ltd.; SURFLON 5-112®, SURFLON 5-113®, SURFLON S-131®, SURFLON S-141®, and SURFLON S-145® of ASAHI Glass Co., Ltd.; and SH-28PA®, SH-190®, SH-193®, SZ-6032©, and SF-8428©, and the like of Toray Silicone Co., Ltd.; F-482, F-484, F-478, F-554 and the like of DIC Co., Ltd.

The fluorine-based surfactant may be included in an amount of 0.001 parts by weight to 5 parts by weight based on 100 parts by weight of components constituting the quantum dot-containing layer. When the fluorine-based surfactant is included within the range, excellent wetting on a glass substrate as well as coating uniformity may be secured, but a stain may not be produced.

In addition, a certain amount of other additives such as antioxidants and stabilizers may be further added to the quantum dot-containing layer within a range that does not impair physical properties.

A method of manufacturing each of the quantum dot-containing layers may include coating a curable composition including the above-described components and the like on a substrate by an ink jet spraying method (S1) to form a pattern; and curing the pattern (S2).

### (S1) Formation of Pattern

The curable composition is coated on a substrate in a thickness of 0.5 to 10 μm in an ink jet dispersion method. According to the inkjet dispersion, a pattern may be formed by repetitively dispersing desired colors one by one or simultaneously dispersing the desired colors to simplify the process.

### (S2) Curing

A cured resin film can be obtained by curing the obtained pattern. At this time, a thermal curing process is preferable as a method of curing. The thermal curing process may be a process of first removing the solvent in the curable composition by heating at a temperature of greater than or equal to about 100° C. for about 3 minutes, and then curing by heating at a temperature of 160° C. to 300° C., and more desirably heating at a temperature of 180° C. to 250° C. for about 30 minutes.

In addition, each of the quantum dot-containing layers may be manufactured without ink jetting. The manufacturing method in this case includes, coating the curable composition including the aforementioned components, for example, at a thickness of 0.5 μm to 10 μm using a suitable method such as spin coating, roller coating, spray coating, etc. on a substrate subjected to a predetermined pretreatment, and irradiating the resultant with light to form a pattern required for the color filter. As a light source used for irradiation, UV, electron beam, or X-ray may be used, and for example, UV in a region of 190 nm to 450 nm, specifically 200 nm to 400 nm may be irradiated. In the irradiation process, a photoresist mask may be further used. After performing the irradiation process in this way, the composition layer irradiated with the light source is treated with a developing solution. At this time, the unexposed portion of the composition layer is dissolved to form a pattern necessary for the color filter. By repeating this process according to the number of required colors, a color filter having a desired pattern may be obtained. In addition, when an image pattern obtained by development in the above process is heated again or cured by irradiation with actinic rays, crack resistance and solvent resistance may be improved.

The curable composition may further include a solvent.

The solvent may include compounds of alcohols such as methanol, ethanol, and the like; glycol ethers such as ethylene glycol methylether, ethylene glycol ethylether, propylene glycol methylether, and the like; cellosolve acetates such as methyl cellosolve acetate, ethyl cellosolve acetate, diethyl cellosolve acetate, and the like; carbitols such as methylethyl carbitol, diethyl carbitol, diethylene glycol monomethylether, diethylene glycol monoethylether, diethylene glycol dimethylether, diethylene glycol methylethylether, diethylene glycol diethylether, and the like; propylene glycol alkylether acetates such as propylene glycol monomethylether acetate, propylene glycol propylether acetate, and the like; ketones such as methylethylketone, cyclohexanone, 4-hydroxy-4-methyl-2-pentanone, methyl-n-propylketone, methyl-n-butylketone, methyl-n-amylketone, 2-heptanone, and the like; saturated aliphatic monocarboxylic acid alkyl esters such as ethyl acetate, n-butyl acetate, isobutyl acetate, and the like; lactic acid alkyl esters such as methyl lactate, ethyl lactate, and the like; hydroxyacetic acid alkyl esters such as methyl hydroxyacetate, ethyl hydroxyacetate, butyl hydroxyacetate, and the like; acetic acid alkoxyalkyl esters such as methoxymethyl acetate, methoxyethyl acetate, methoxybutyl acetate, ethoxymethyl acetate, ethoxyethyl acetate, and the like; 3-hydroxypropionic acid alkyl esters such as methyl 3-hydroxypropionate, ethyl 3-hydroxypropionate, and the like; 3-alkoxypropionic acid alkyl esters such as methyl 3-methoxypropionate, ethyl 3-methoxypropionate, ethyl 3-ethoxypropionate, methyl 3-ethoxypropionate, and the like; 2-hydroxypropionic acid alkyl esters such as methyl 2-hydroxypropionate, ethyl 2-hydroxypropionate, propyl 2-hydroxypropionate, and the like; 2-alkoxypropionic acid alkyl esters such as methyl 2-methoxypropionate, ethyl 2-methoxypropionate, ethyl 2-ethoxypropionate, methyl 2-ethoxypropionate, and the like; 2-hydroxy-2-methylpropionic acid alkyl esters such as methyl 2-hydroxy-2-methylpropionate, ethyl 2-hydroxy-2-methylpropionate, and the like; 2-alkoxy-2-methylpropionic acid alkyl esters such as methyl 2-methoxy-2-methylpropionate, ethyl 2-ethoxy-2-methylpropionate, and the like; esters such as 2-hydroxyethyl propionate, 2-hydroxy-2-methylethyl propionate, hydroxyethyl acetate, methyl 2-hydroxy-3-methylbutanoate, and the like; or ketone acid esters such as ethyl pyruvate, and the like. In addition, N-methylformamide, N,N-dimethyl formamide, N-methylformanilide, N-methylacetamide, N,N-dimethyl acetamide, N-methylpyrrolidone, dimethylsulfoxide, benzylethylether, dihexylether, acetylacetone, isophorone, caproic acid, caprylic acid, 1-octanol, 1-nonanol, benzylalcohol, benzyl acetate, ethyl benzoate, diethyl oxalate, diethyl maleate, γ-butyrolactone, ethylene carbonate, propylene carbonate, phenyl cellosolve acetate, dimethyladipate may also be used, but is not limited thereto.

For example, the solvent may be desirably glycol ethers such as ethylene glycol monoethylether, ethylene diglycol methylethylether, and the like; ethylene glycol alkylether acetates such as ethyl cellosolve acetate, and the like; esters such as 2-hydroxy ethyl propionate, and the like; carbitols such as diethylene glycol monomethylether, and the like; propylene glycol alkylether acetates such as propylene glycol monomethylether acetate, propylene glycol propylether acetate, and the like; alcohols such as ethanol, and the like, or a combination thereof.

For example, the solvent may include propylene glycol monomethylether acetate, dipropylene glycol methylether acetate, ethanol, ethylene glycol dimethylether, ethylene diglycol methylethylether, diethylene glycol dimethylether, dimethyl acetamide, 2-butoxyethanol, N-methylpyrrolidine, N-ethylpyrrolidine, propylene carbonate, γ-butyrolactone, dimethyladipate, or a combination thereof.

The solvent may be included in a balance amount based on the total amount of the curable composition.

### MODE FOR INVENTION

Hereinafter, the present invention is illustrated in more detail with reference to examples. These examples, however, are not in any sense to be interpreted as limiting the scope of the invention.

### Synthesis Examples

### Synthesis Example 1: Synthesis of Intermediate 1

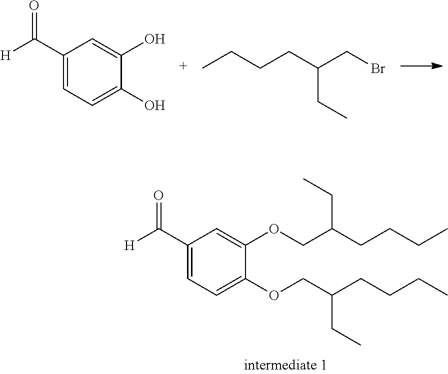

3,4-dihydroxybenzaldehyde (20 g, 0.14 mol), 1-bromo-2-ethylhexane (84 g, 0.43 mol), potassium carbonate (60 g, 0.43 mol), and 160 ml of DMF were added to a 500 ml of RBF and after increasing a temperature to 140° C., stirred for 3 hours. When a reaction was completed, after decreasing the temperature to room temperature, the resultant was extracted by using ethyl acetate.

After the extraction, an extract therefrom was separated through column chromatography to synthesize Intermediate 1.

### Synthesis Example 2: Synthesis of Intermediate 2

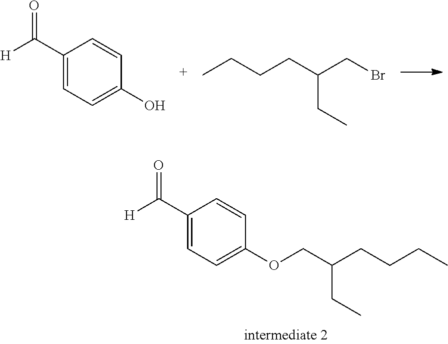

Intermediate 2 was synthesized in the same manner as in Synthesis Example 1 except that 4-hydroxybenzaldehyde was used instead of the 3,4-dihydroxybenzaldehyde.

### Synthesis Example 3: Synthesis of Intermediate 3

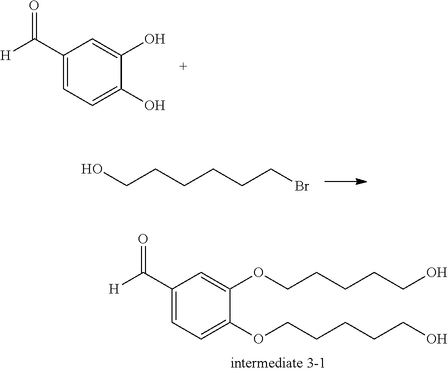 [SMILES: O=Cc1ccc(O)c(O)c1 ; OCCCCCCBr ; O=Cc1ccc(OCCCCCO)c(OCCCCCO)c1]

Intermediate 3-1 was synthesized in the same manner as in Synthesis Example 1 except that 6-bromo-1-hexanol was used instead of the 1-bromo-2-ethylhexane.

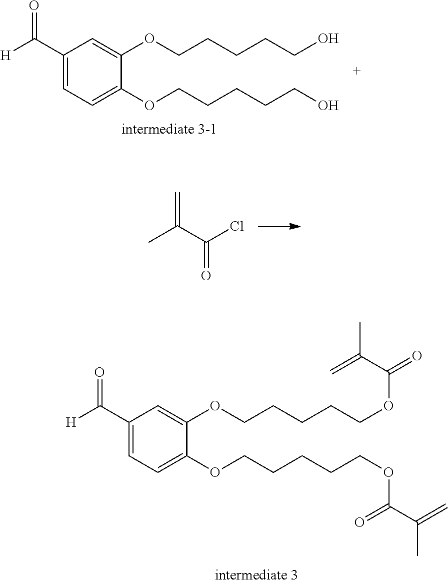

Intermediate 3-1 (15 g, 0.044 mol), trimethylamine (11.21 g, 0.11 mol), and 300 ml of dichloromethane were added thereto and then, stirred in an ice bath. Methacryloyl chloride (11.11 g, 0.11 mol) was added thereto in a dropwise fashion.

After stirring the mixture for 2 hours, the resultant was extracted with dichloromethaned and then, concentrated and dried to obtain Intermediate 3.

### Synthesis Example 4: Synthesis of Intermediate 4

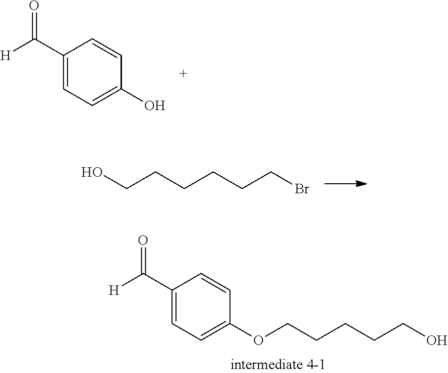 [SMILES: O=Cc1ccc(O)cc1 ; OCCCCCCBr ; O=Cc1ccc(OCCCCCO)cc1]

Intermediate 4-1 was synthesized in the same manner as in Synthesis Example 3 except that 4-hydroxybenzaldehyde was used instead of the 3,4-dihydroxybenzaldehyde.

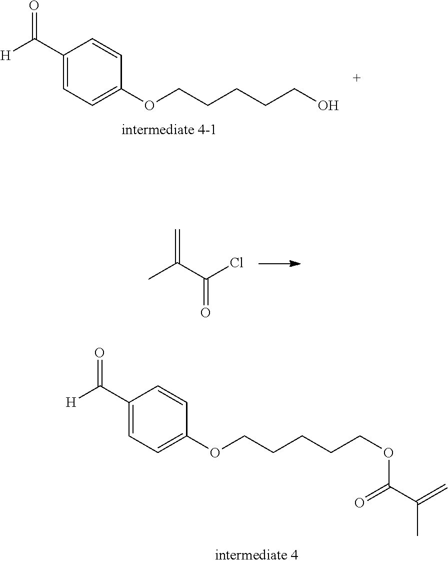

Intermediate 4 was synthesized in the same manner as in Synthesis Example 3 except that Intermediate 4-1 was used instead of Intermediate 3-1.

### EXAMPLE

### Example 1: Synthesis of Compound Represented by Chemical Formula 1-1-1

### [Chemical Formula 1-1-1]

(1) Intermediate 1 (3 eq), Intermediate 3 (1 eq), 10 volumes of propionic acid, and pyrrole (4 eq) were added to 500 ml of RBF after increasing a temperature at 130° C., stirred for 6 hours. When a reaction was completed, after decreasing the temperature to room temperature, 100 g of acetone was added thereto and then, stirred. A solid compound produced therein was filtered with a filter, washed with acetone, and dried, synthesizing a metal-free porphyrin intermediate.

(2) The metal-free porphyrin intermediate (1 eq), 10 volumes of DMF, and 10 eq of vanadium oxide were added to 500 ml of and then, stirred at 140° C. overnight to complete a reaction. After decreasing the temperature, the resultant was extracted by using ethyl acetate. An extract therefrom was separated and purified through column chromatography. After proceeding with drying, a compound represented by Chemical Formula 1-1-1 was obtained.

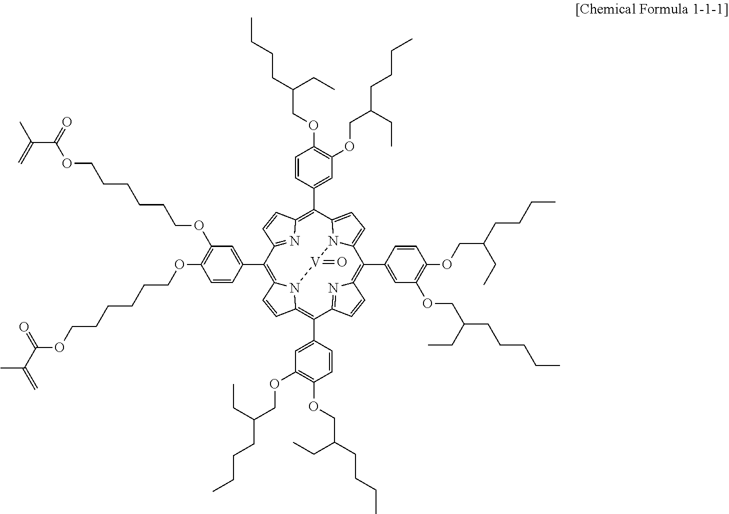

### Example 2: Synthesis of Compound Represented by Chemical Formula 1-1-2

A compound represented by Chemical Formula 1-1-2 was synthesized in the same manner as in Example 1 except that Intermediate 1 (2 eq) and Intermediate 3 (2 eq) were used instead of Intermediate 1 (3 eq) and Intermediate 3 (1 eq).

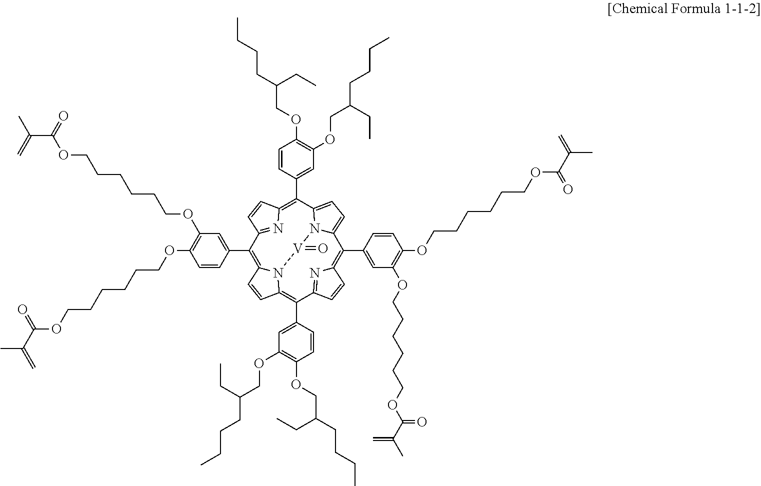

### Example 3. Synthesis of Compound Represented by Chemical Formula 1-1-3

A compound represented by Chemical Formula 1-1-3 was synthesized in the same manner as in Example 1 except that Intermediate 1 (1 eq) and Intermediate 3 (3 eq) were used instead of Intermediate 1 (3 eq) and Intermediate 3 (1 eq).

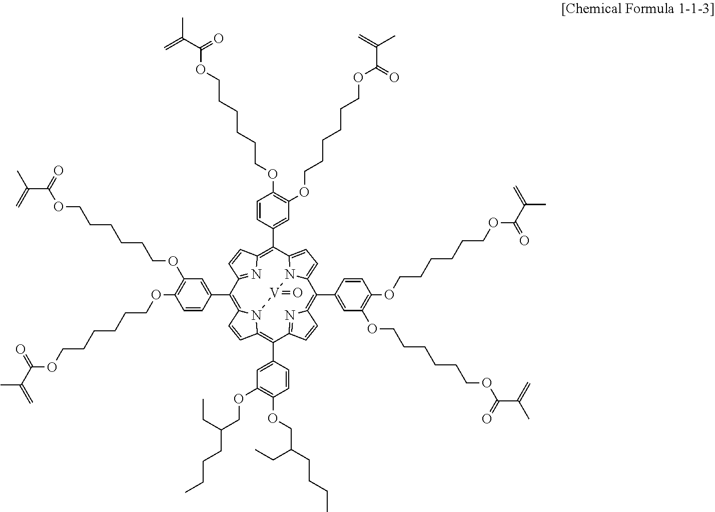

### Example 4. Synthesis of Compound Represented by Chemical Formula 1-1-4

A compound represented by Chemical Formula 1-1-4 was synthesized in the same manner as in Example 1 except that Intermediate 1 (0 eq, that is, no use of Intermediate 1) and Intermediate 3 (4 eq) were used instead of Intermediate 1 (3 eq) and Intermediate 3 (1 eq).

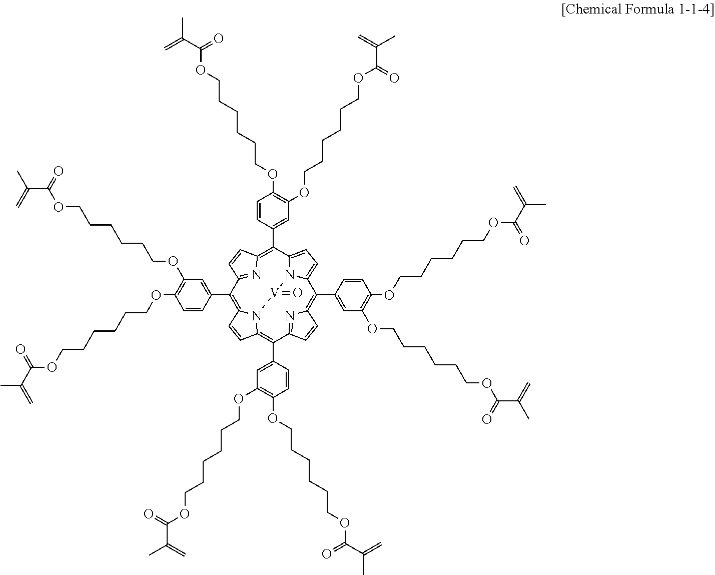

### ([M+H]2152.05)

### Example 5. Synthesis of Compound Represented by Chemical Formula 1-2-1

A compound represented by Chemical Formula 1-2-1 was synthesized in the same manner as in Example 1 except that Intermediate 1 (2 eq), Intermediate 2 (1 eq), Intermediate 3 (0 eq, that is, no use of Intermediate 1), and Intermediate 4 (1eq) were used instead of Intermediate 1 (3 eq) and Intermediate 3 (1 eq).

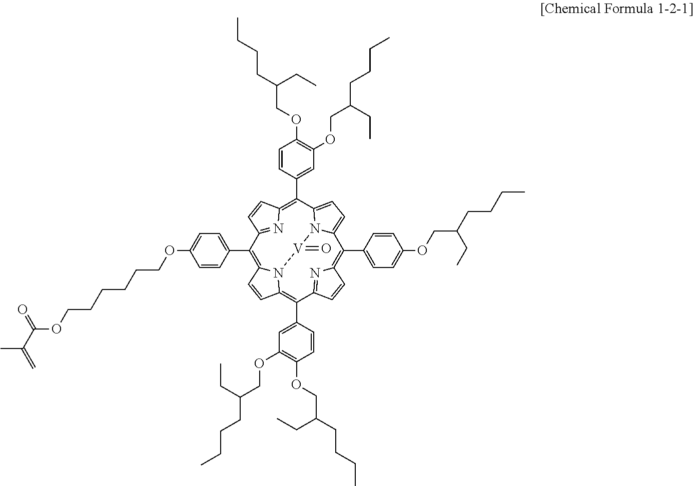

### ([M+H]1503.88)

### Example 6: Synthesis of Compound Represented by Chemical Formula 1-2-6

A compound represented by Chemical Formula 1-2-6 was synthesized in the same manner as in Example 5 except that cupper acetate (2 eq) was used instead of the vanadium oxide.

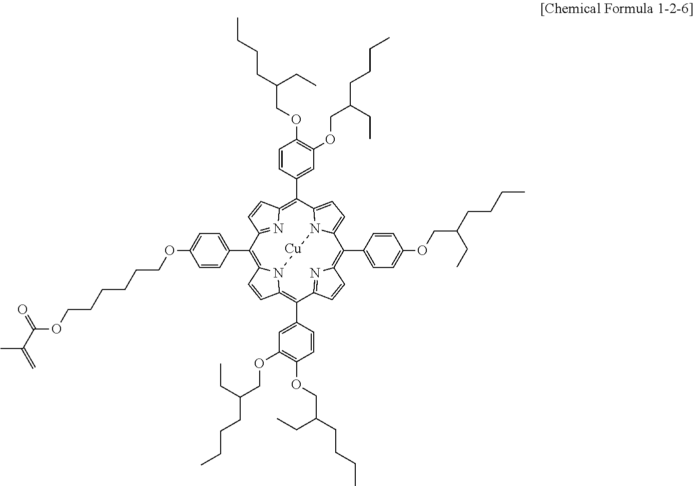

### ([M+H]1499.87)

### Comparative Example 1: Synthesis of Compound represented by Chemical Formula A

A compound represented by Chemical Formula A was synthesized in the same manner as in Example 1 except that Intermediate 1 (2 eq), Intermediate 2 (1 eq), Intermediate 3 (0 eq, that is, no use of Intermediate 1) were used instead of Intermediate 1 (3 eq) and Intermediate 3 (1 eq).

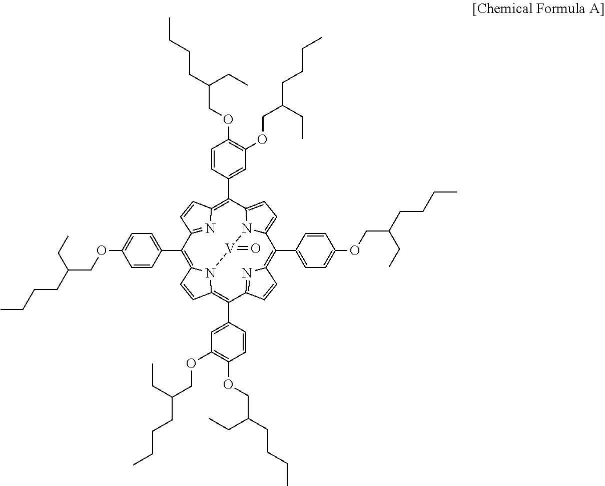

### ([M+H]1447.89)

### Comparative Example 2: Synthesis of Compound Represented by Chemical Formula B

A compound represented by Chemical Formula B was synthesized in the same manner as in Example 1 except that 3,4-butoxybenzaldehyde (2 eq) and 4-butoxybenzaldehyde (2 eq) were used instead of Intermediate 1 (3 eq) and Intermediate 3 (1 eq).

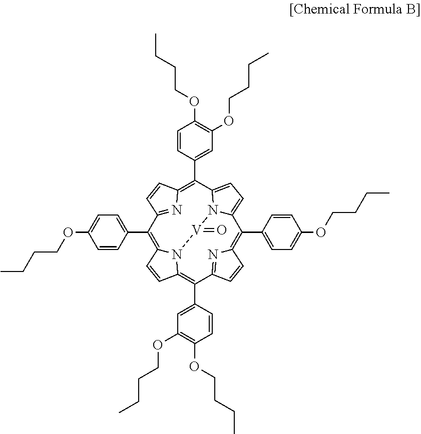

### ([M+H]1111.52)

### (Evaluation)

Evaluation 1: Evaluation of Compound characteristics

(1) Absorption wavelength range and maximum absorption wavelength Each of the compounds of Examples 1 to 6 and Comparative Examples 1 and 2 was mixed with a diluting solvent (PGMEA) to prepare a diluted solution at a concentration of 0.005 wt %, which was analyzed by using an ultraviolet-visible spectrometer (Model name: UV-2550, Manufacturer: Shimadzu Scientific Instruments.) to obtain an absorption spectrum. In the absorption spectrum of each of the compounds, a maximum absorption wavelength (λₘₐₓ) was checked and provided in Table 1.

### (2) Solubility

Each of the compounds according to Examples 1 to 6 and Comparative Examples 1 and 2 were measured with respect to a maximum weight dissolved in 10 g of PGMEA. Specifically, the maximum weight of the compound dissolved in the PGMEA based on a total weight of the obtained solution was calculated as a percentage, and the result is provided as solubility in Table 1.

TABLE 1

| | Maximum absorption | Solubility |
|---|---|---|
| | wavelength (nm) | (%) |
| Example 1 | 431 | 10% |
| Example 2 | 432 | 10% |
| Example 3 | 432 | 8% |
| Example 4 | 431 | 8% |
| Example 5 | 428 | 10% |
| Example 6 | 420 | 3% |
| Comparative Example 1 | 429 | 3% |
| Comparative Example 2 | 428 | 2% |

Referring to Table 1, the compounds according to Examples 1 to 6 and Comparative Examples 1 and 2 commonly exhibited a maximum absorption wavelength at 420 nm to 440 nm.

However, the compounds according to Examples 1 to 6, in which a functional group of C1 to C20 alkoxy groups substituted with a (meth)acrylate group at the terminal end was introduced into at least one of R⁹ to R²⁸ of Chemical Formula 1, unlike the compounds according to Comparative Examples 1 and 2, exhibited at least twice (at most 5 times) improved solubility.

### (Manufacturing of Antireflection Film)

### Example 7

100 parts by weight of a monomer mixture including 99 parts by weight of n-butylacrylate and 1 part by weight of 2-hydroxyethylacrylate and 150 parts by weight of ethylacetate were put into a 1 L reactor equipped with a condenser to conveniently control a temperature, in which nitrogen gas was refluxed, and while the flask was stirred, nitrogen gas was injected thereinto for 1 hour to substitute nitrogen for oxygen in the reactor, and then, the reactor was maintained at 70° C. 0.06 parts by weight of 2,2′-azobisisobutyronitrile as an initiator was added thereto and then, reacted for 8 hours to prepare a solution containing a (meth)acrylic copolymer. The (meth)acrylic copolymer had Tg of −46° C. and a weight average molecular weight of 1,100,000 g/mol. Subsequently, ethylacetate was added thereto, preparing 19.4 wt % of a (meth)acrylic copolymer solution. Based on the solid content of 100 parts by weight of the (meth)acrylic copolymer, 0.193 parts by weight of an XDI-based isocyanate-based crosslinking agent (75% of a solid content, TD-75, Soken Chemical Co., Ltd.), 0.154 parts by weight of 3-glycidoxypropyl trimethoxysilane (KBM-403, ShinEtsu Chemical Co.) as a silane coupling agent, and 0.06 parts by weight of the compound according to Example 1 were mixed. Subsequently, 25 parts by weight of methylethylketone was added thereto to prepare an adhesive layer composition.

The adhesive layer composition was directly coated with a bar-coater on the bottom surface of a PET film, which was a base film of an antireflection layer (an antireflection layer formed by sequentially stacking a hard coating layer, a high refractive layer, and a low refractive layer on the upper surface of the PET film, Reflectance: 0.2%, DNP, LLC) and then, dried in a 90° C. oven for 4 minutes to form a 20 μm-thick antireflection film.

### Example 8

An antireflection film was formed in the same manner as in Example 7 except that the compound of Example 2 was used instead of the compound of Example 1.

### Example 9

An antireflection film was formed in the same manner as in Example 7 except that the compound of Example 3 was used instead of the compound of Example 1.

### Example 10

An antireflection film was formed in the same manner as in Example 7 except that the compound (represented by Chemical Formula 1-4) of Example 4 was used instead of the compound of Example 1.

### Example 11

An antireflection film was formed in the same manner as in Example 7 except that the compound of Example 5 was used instead of the compound of Example 1.

### Example 12

An antireflection film was formed in the same manner as in Example 7 except that the compound of Example 6 was used instead of the compound of Example 1.

### Comparative Example 3

An antireflection film was formed in the same manner as in Example 7 except that the compound of Comparative Example 1 was used instead of the compound of Example 1.

### Comparative Example 4

An antireflection film was formed in the same manner as in Example 7 except that the compound of Comparative Example 1 was used instead of the compound of Example 2.

### Evaluation 2: Evaluation of Antireflection Film Properties

### (1) Manufacturing of Specimens

In order to check whether light resistance reliability of a film for a panel to which quantum dots were applied was improved or not, each of the antireflection films according to Examples 1 to 7 and Comparative Examples 1 and 2 was laminated on the other surface of a glass plate with a quantum dot-containing layer on one surface to obtain specimens.

### (2) Light Resistance Reliability

The antireflection films on the specimens were evaluated with respect to light resistance reliability by measuring a change in light transmittance at a maximum absorption wavelength of each compound before and after irradiating them in a xenon test chamber (Q-SUN) under the conditions of [light source lamp: Xenon lamp, irradiation intensity: 0.35 W/cm², irradiation temperature: 63° C., irradiation time: 500 hours, irradiation direction: irradiation from the antireflection film side], and the results are shown in Table 2. The light transmittance change was calculated according to Equation 1 and then, expressed as ΔEab¹* as a criteria of color change.

$$Δ E a {b}^{1 *} = \{ ( Δ {L}^{*} ) 2 + ( Δ {a}^{*} ) 2 + ( Δ {b}^{*} ) 2 \} \times 1 / 2 \qquad [ Equation 1 ]$$

For reference, the smaller ΔEab¹* according to Equation 1, the more excellent light resistance reliability.

### (3) Release Resistant Properties

3 ml of PGMEA (propylene glycol methyl ether acetate) was applied on each of the antireflection films of the specimens and then, maintained on a hot plate at 85° C. for 135s. Color values before and after the PGMEA treatment were measured by using MCPD (Otsuka Electronics Co., Ltd.) equipment. Release resistant properties were calculated according to Equation 2 and then, provided as a color change criteria of ΔEab²*. The results are shown in Table 2.

$$Δ E a {b}^{2 *} = \{ ( Δ {L}^{*} ) 2 + ( Δ {a}^{*} ) 2 + ( Δ {b}^{*} ) 2 \} \times 1 / 2 \qquad [ Equation 2 ]$$

For reference, the smaller ΔEab²* according to Equation 2, the more excellent release resistant properties.

### (4) Migration Degree

A PSA film was adhered onto each of the antireflection films of the specimens and then, maintained at 85° C. for 24 hr. Color values of the PSA film before the adherence onto the antireflection films and 24 hr after the adherence were measured by using MCPD (Otsuka Electronics Co., Ltd.) equipment. ΔEab³* was calculated as a color change criteria, and the results are shown in Table 2.

$$Δ E a {b}^{3 *} = \{ ( Δ {L}^{*} ) 2 + ( Δ {a}^{*} ) 2 + ( Δ {b}^{*} ) 2 \} \times 1 / 2 \qquad [ Equation 3 ]$$

For reference, the smaller ΔEab³* according to Equation 3, the more excellent migration inhibition characteristics.

TABLE 2

| | Light | Release | |
|---|---|---|---|
| | resistance | resistant | Migration |
| | reliability | properties | degree |
| | (ΔEab*) | (ΔEab*) | (ΔEab*) |
| Example 7 | 0.52 | 0.16 | 1.52 |
| Example 8 | 0.45 | 0.13 | 1.41 |
| Example 9 | 0.32 | 0.13 | 1.18 |
| Example 10 | 0.31 | 0.12 | 1.15 |
| Example 11 | 0.42 | 0.13 | 1.32 |
| Example 12 | 0.25 | 0.14 | 1.78 |
| Comparative Example 3 | 1.56 | 2.4 | 3.14 |
| Comparative Example 4 | 1.81 | 2.1 | 3.29 |

Referring to Table 2, the antireflection films according to Examples 7 to 12, compared with the antireflection films according to Comparative Examples 3 and 4, exhibited all excellent light resistance reliability, release resistant properties, and migration inhibition characteristics.

This confirmed that the antireflection films overcame the shortcomings of porphyrin-based dyes and realized excellent characteristics such as light resistance reliability, release resistant properties, migration inhibition, and the like by introducing a functional group of a C1 to C20 alkoxy group substituted with a (meth)acrylate group at the terminal end into at least one of R⁹ to R²⁸ of Chemical Formula 1.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

### DESCRIPTION OF SYMBOLS

10 blue light source
20 quantum dot-containing layer
30 color filter
40 substrate
50 adhesive layer
60 dye-containing layer
70 antireflection layer
80 antireflection film
100 display device

1. A compound represented by Chemical Formula 1: 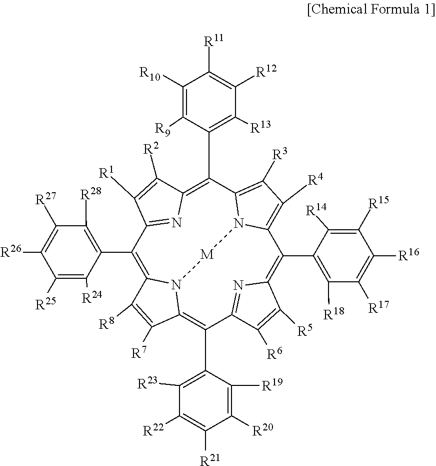
wherein, in Chemical Formula 1,
M is two hydrogen atoms, a divalent metal atom, a trivalent substituted metal atom, a tetravalent substituted metal atom, a hydroxide metal atom, or a metal oxide atom;
R¹ to R⁸ are each independently a hydrogen atom, a halogen atom, a cyano group, a carbonyl group, or a nitro group;
R⁹ to R²⁸ are each independently a substituted or unsubstituted C1 to C20 alkyl group, a substituted or unsubstituted C1 to C20 alkoxy group, *—C(═O)OR (R is a substituted or unsubstituted C1 to C15 alkyl group), a substituted or unsubstituted C3 to C20 cycloalkyl group, or a substituted or unsubstituted C6 to C20 aryl group; and
at least one of R⁹ to R²⁸ is a C1 to C20 alkoxy group having a terminal end substituted with a (meth)acrylate group.

2. The compound as claimed in claim 1, wherein M is V(═O), Cu, Co, Zn, or Ag.

3. The compound as claimed in claim 1, wherein each of R¹ to R⁸ is a hydrogen atom.

4. The compound as claimed in claim 1, wherein:
at least two of R⁹ to R¹³, one or more of R¹⁴ to R¹⁸, at least two of R¹⁹ to R²³, and one or more of R²⁴ to R²⁸ are each a substituted or unsubstituted C1 to C20 alkoxy group, and
at least one of R⁹ to R²⁸ is substituted at a terminal end with a (meth)acrylate group.

5. The compound as claimed in claim 4, wherein;
two or more of R⁹ to R¹³ are substituted or unsubstituted C1 to C20 alkoxy groups bonded with respect to each other at an ortho position,
two or more of R¹⁹ to R²³ are substituted or unsubstituted C1 to C20 alkoxy groups bonded with respect to each other an ortho position.

6. The compound as claimed in claim 5, wherein;
the compound is represented by Chemical Formula 1-1 or 1-2: 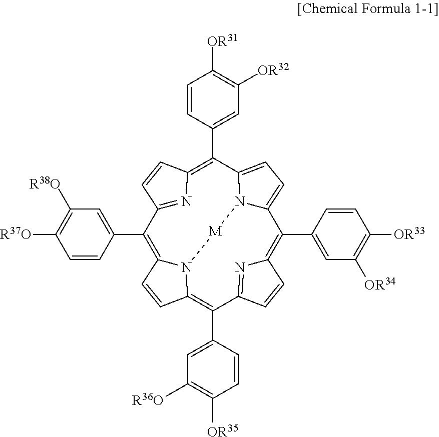
in Chemical Formula 1-1,
R³¹ to R³⁸ are each independently a hydrogen atom, a substituted or unsubstituted C1 to C20 alkyl group, a substituted or unsubstituted C1 to C20 alkoxy group, *—C(═O)OR (R is a substituted or unsubstituted C1 to C15 alkyl group), a substituted or unsubstituted C3 to C20 cycloalkyl group, or a substituted or unsubstituted C6 to C20 aryl group; and
at least one of R³¹ to R³⁸ is a C1 to C20 alkyl group having a terminal end substituted with (meth)acrylate; 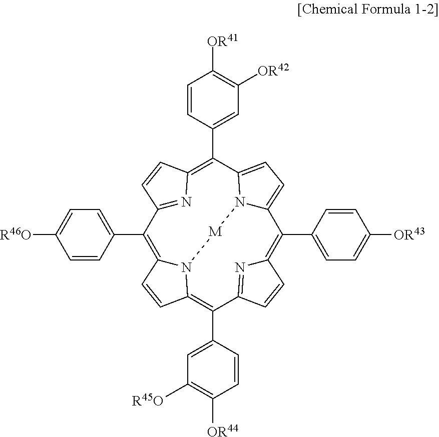
in Chemical Formula 1-2,
R⁴¹ to R⁴⁶ are each independently a hydrogen atom, a substituted or unsubstituted C1 to C20 alkyl group, a substituted or unsubstituted C1 to C20 alkoxy group, *—C(═O)OR (R is a substituted or unsubstituted C1 to C15 alkyl group), a substituted or unsubstituted C3 to C20 cycloalkyl group, or a substituted or unsubstituted C6 to C20 aryl group; and
at least one of R⁴¹ to R⁴⁶ is a C1 to C20 alkyl group having a terminal end substituted with (meth)acrylate.

7. The compound as claimed in claim 6, wherein at least two of R³¹ to R³⁸ are a C1 to C10 alkyl group having a terminal end substituted with (meth)acrylate.

8. The compound as claimed in claim 7, wherein R³¹ to R³⁸ are each a C1 to C10 alkyl group having a terminal end substituted with (meth)acrylate or a C4 to C10 branched alkyl group.

9. The compound as claimed in claim 6, wherein at least two of R⁴¹ to R⁴⁶ are a C1 to C10 alkyl group having a terminal end substituted with (meth)acrylate.

10. The compound as claimed in claim 9, wherein R⁴¹ to R⁴⁶ are each a C1 to C10 alkyl group having a terminal end substituted with (meth)acrylate or a C4 to C10 branched alkyl group.

11. The compound as claimed in claim 1, wherein the compound is represented by one of Chemical Formula 1-1-1 to 1-2-10

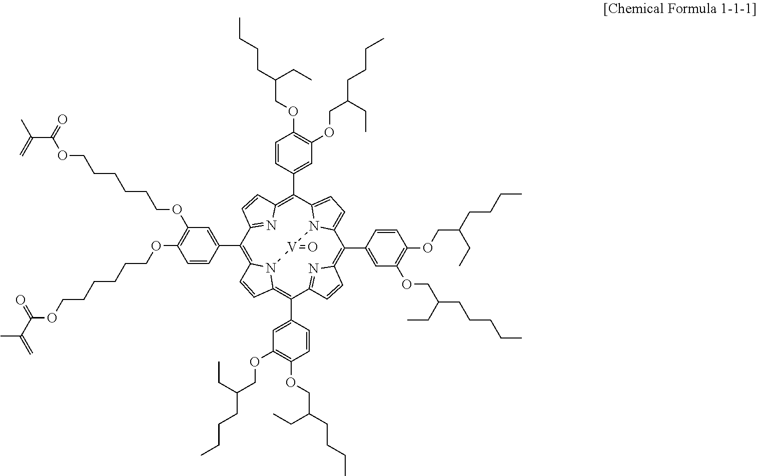

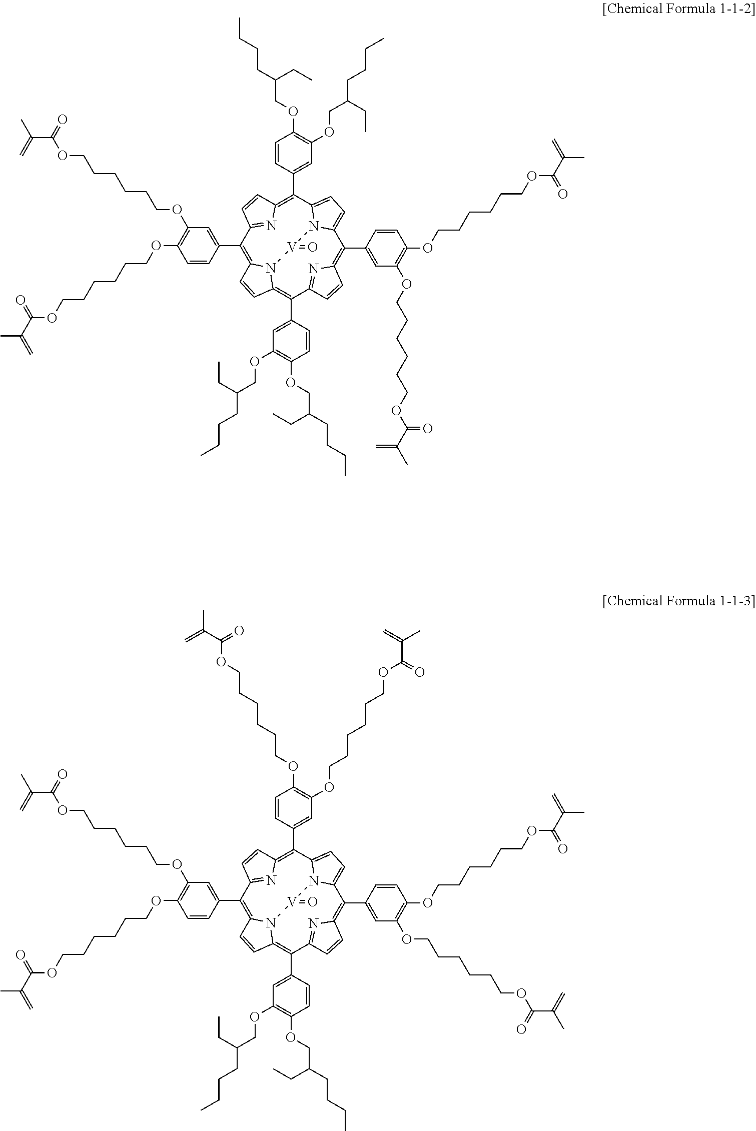

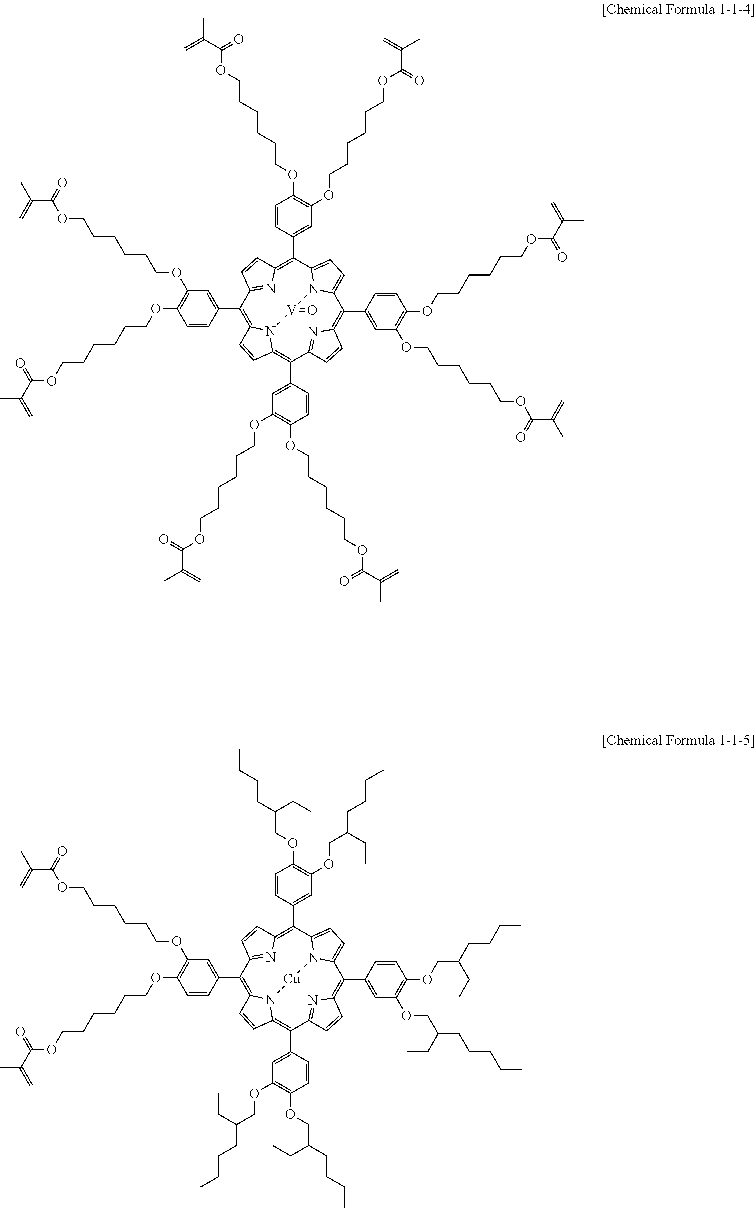

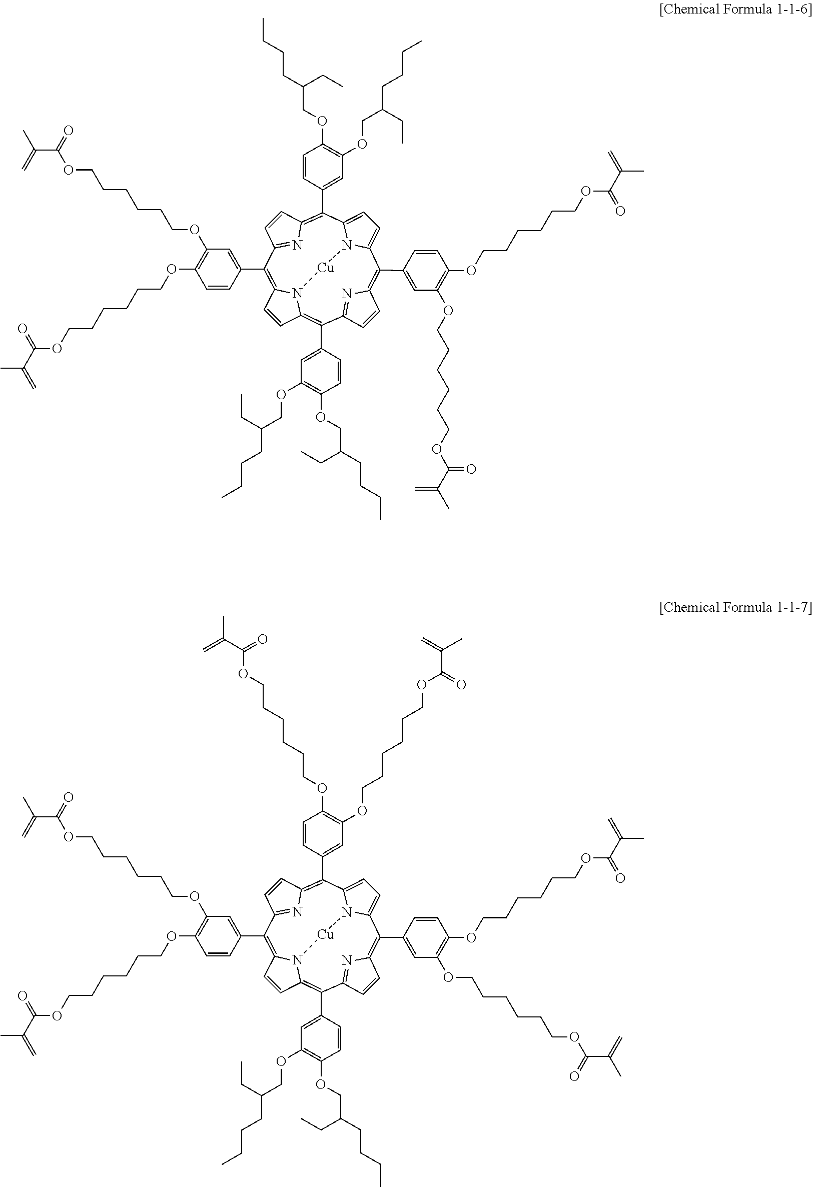

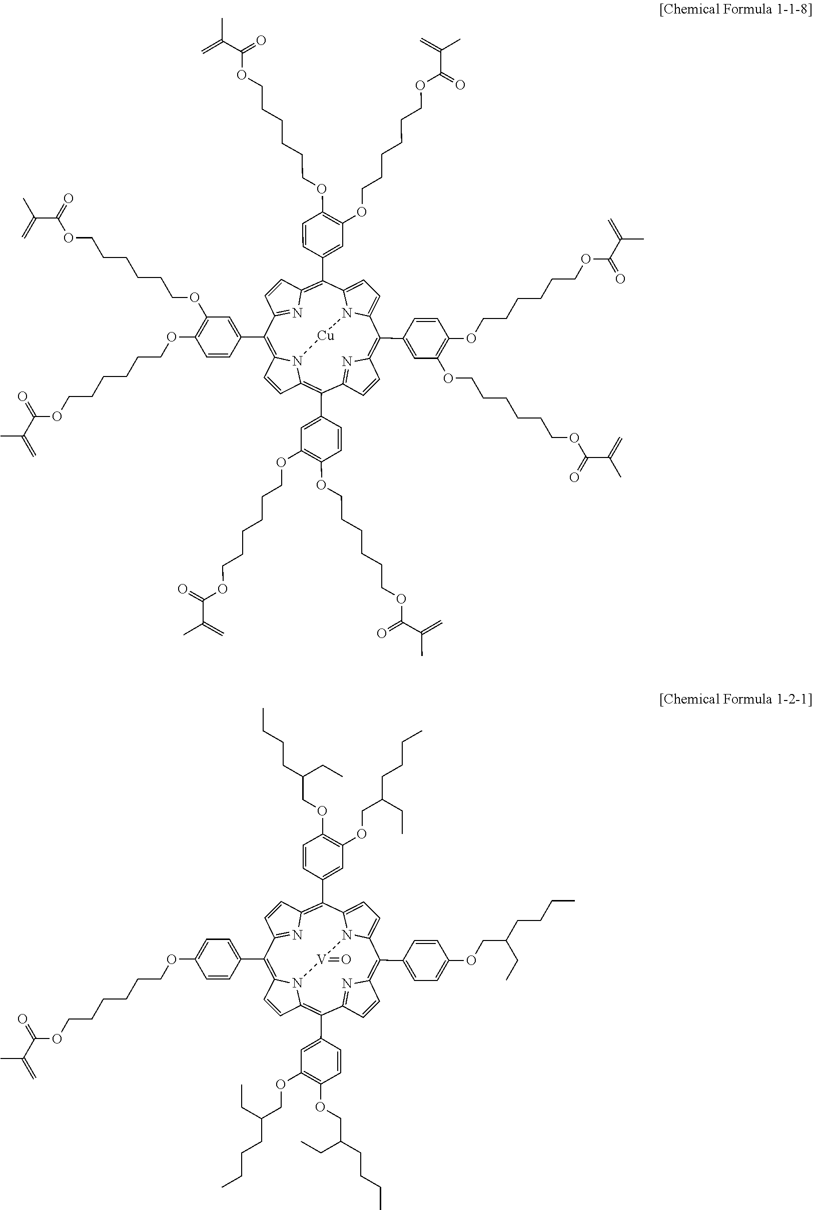

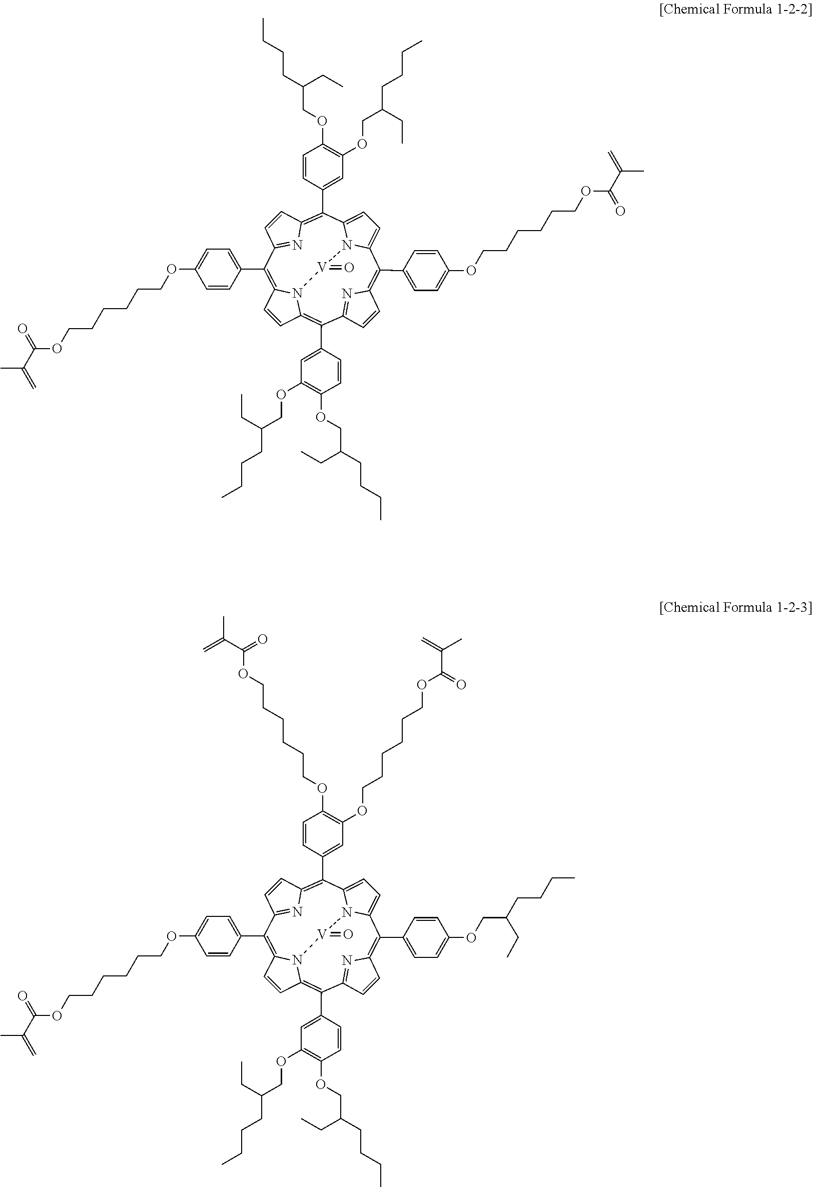

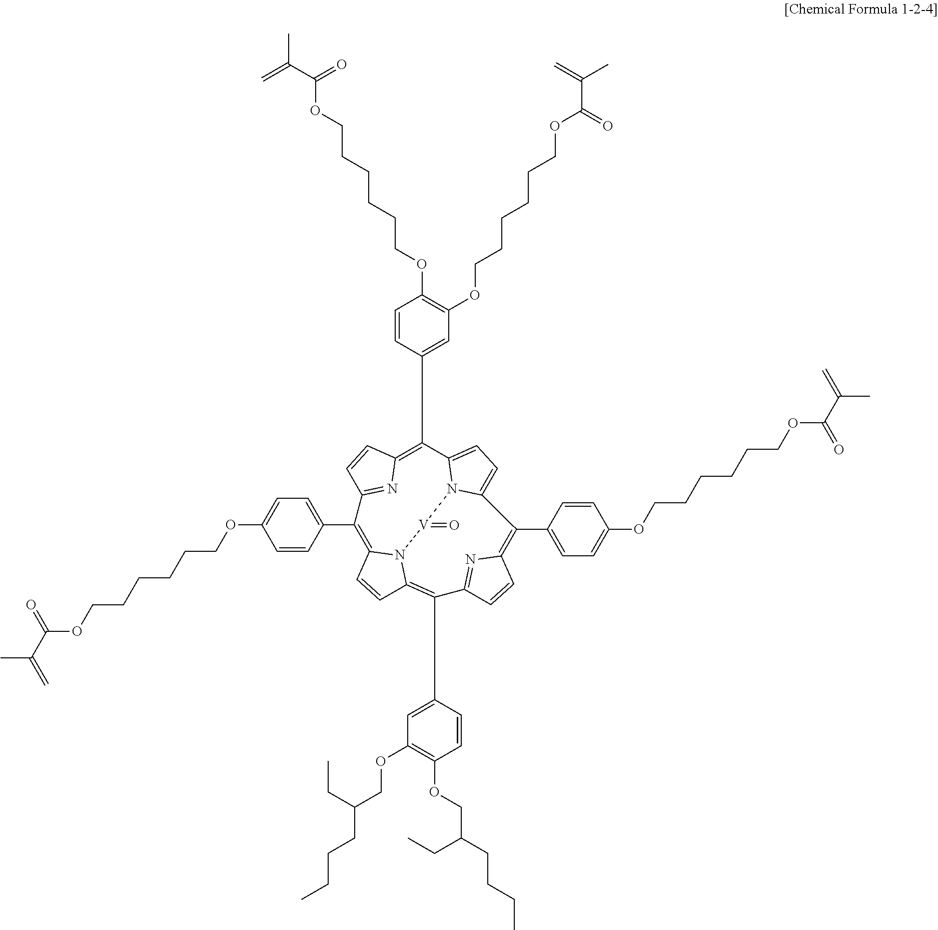

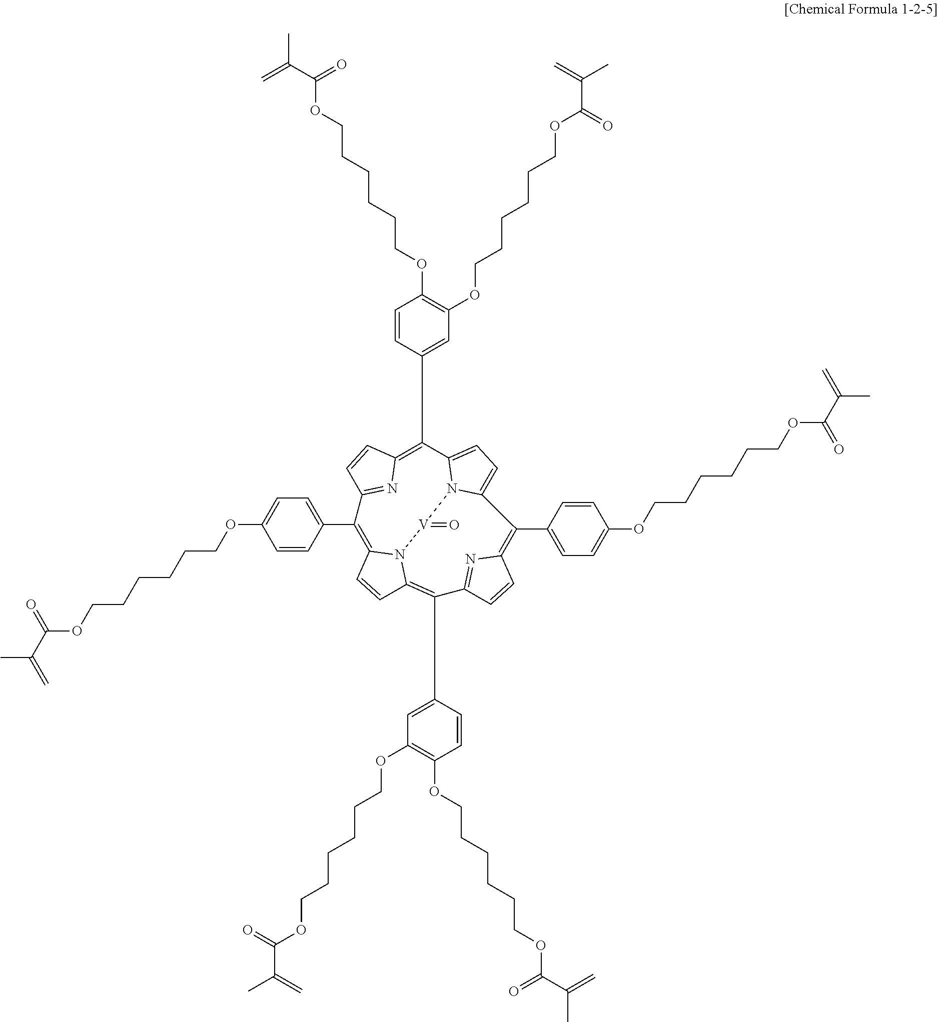

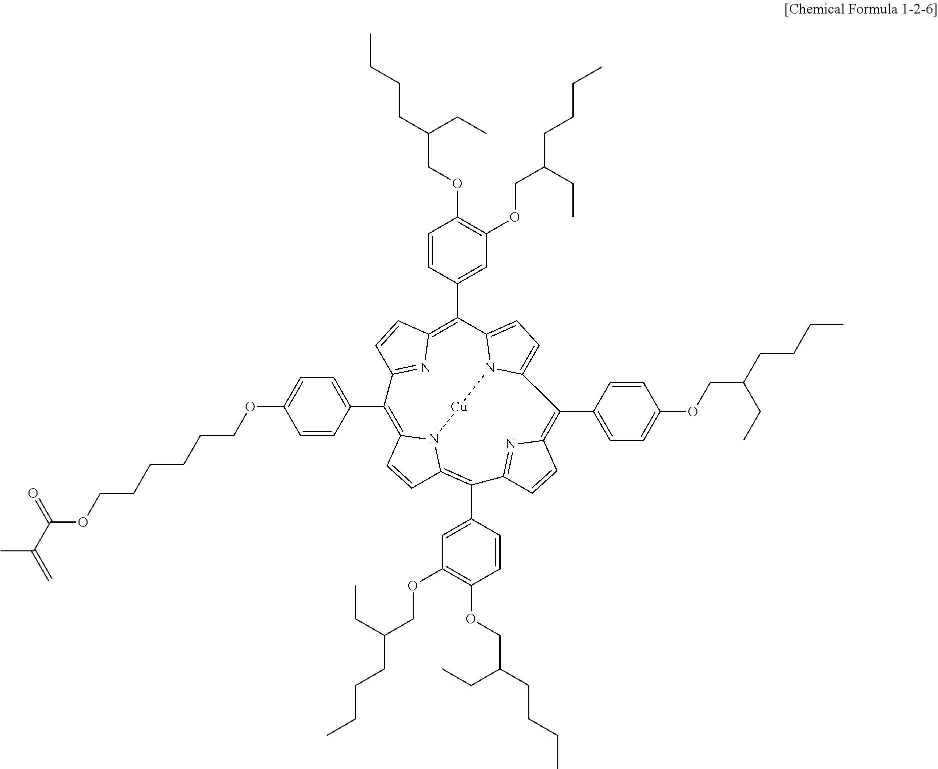

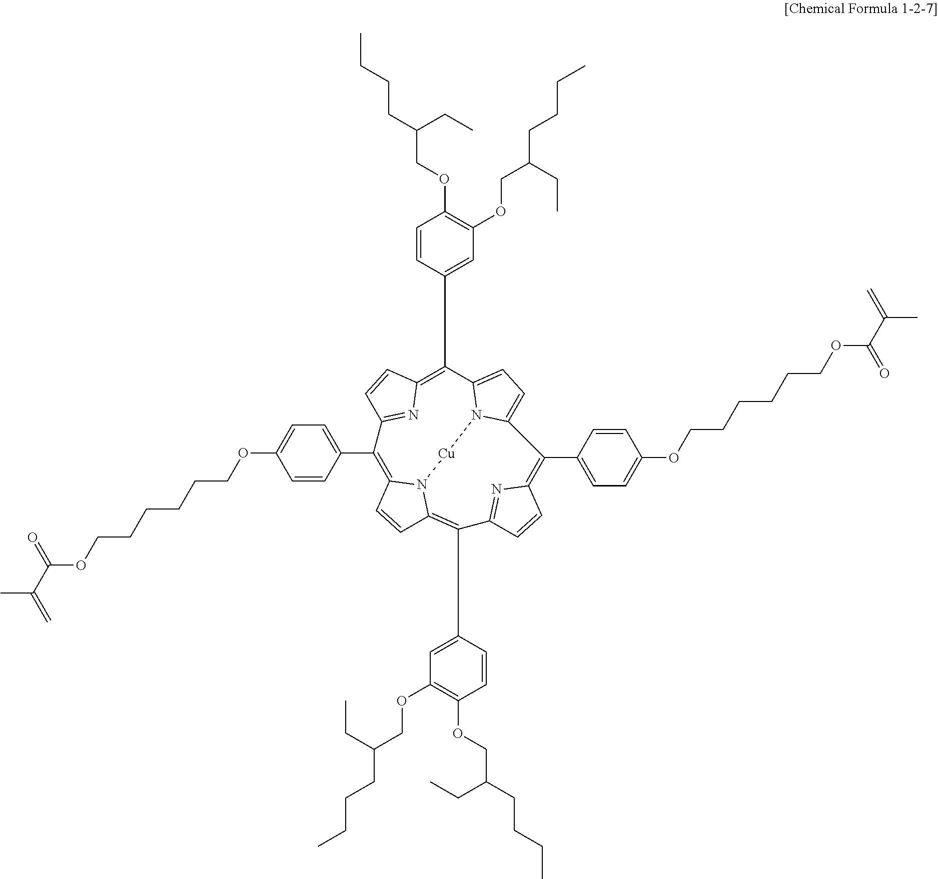

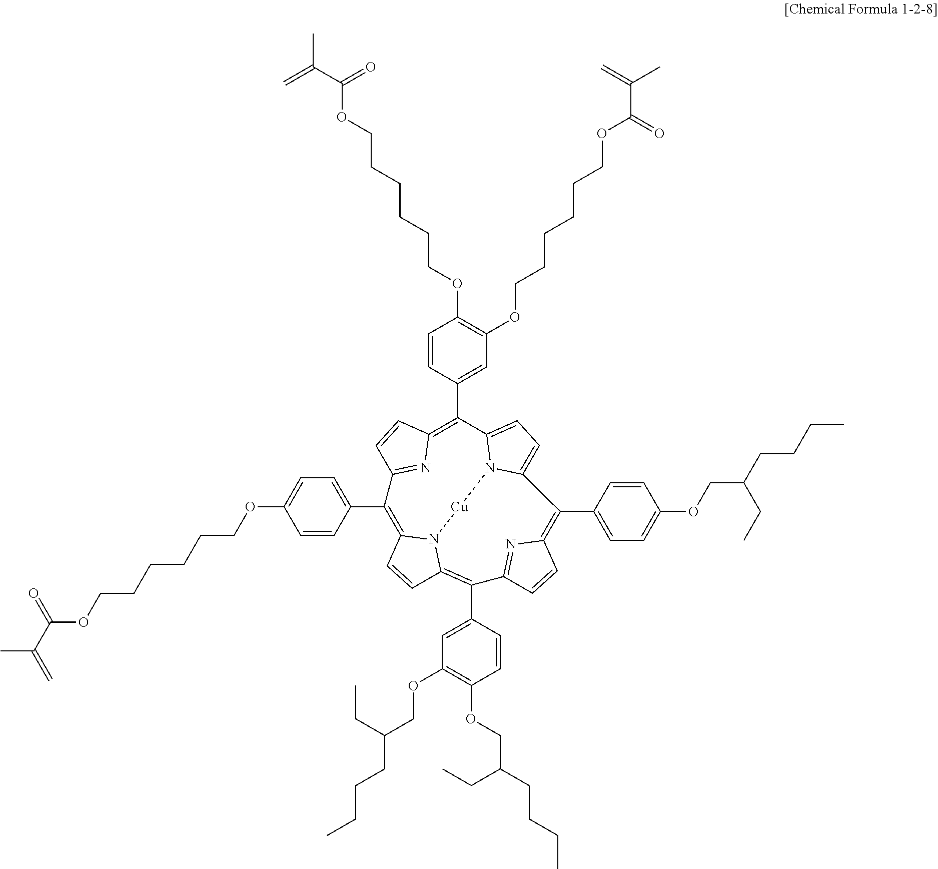

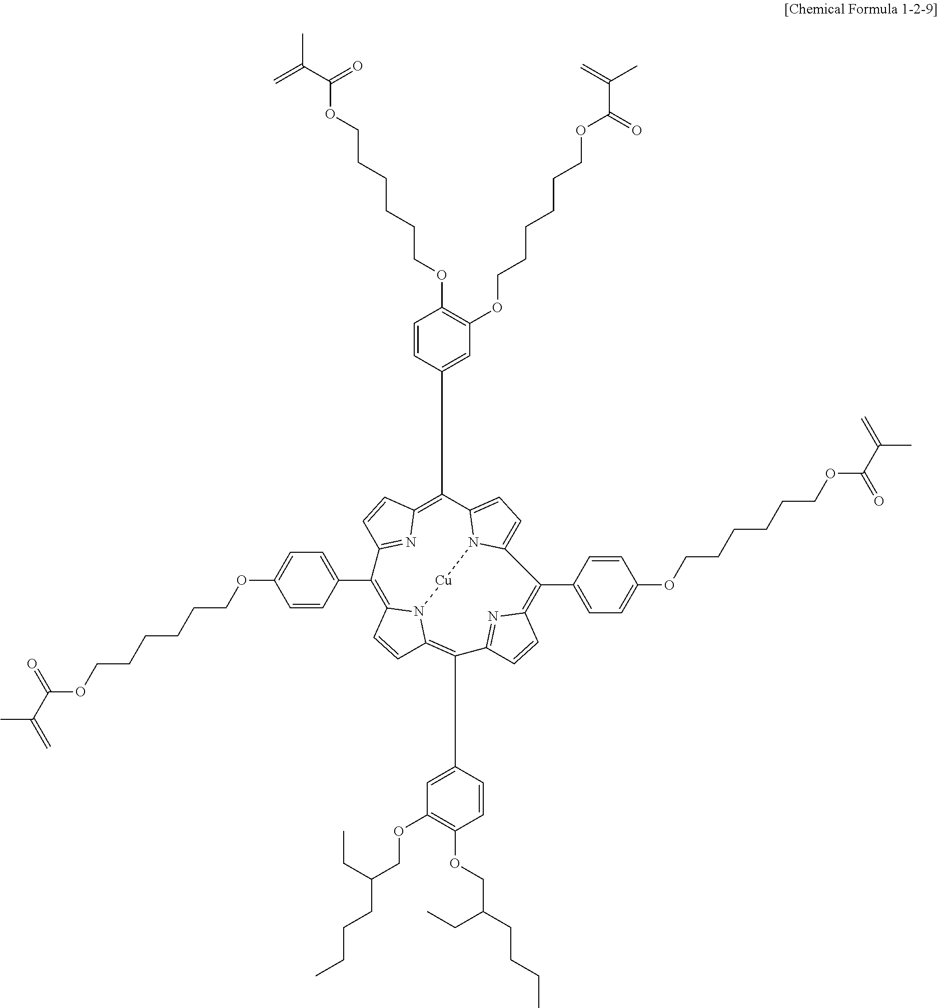

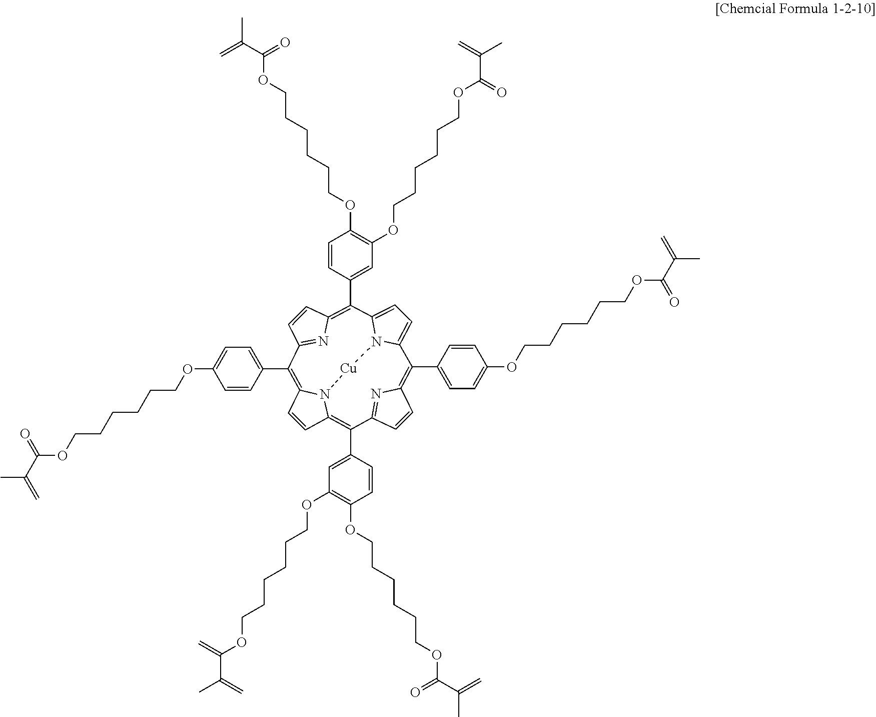

12. The compound as claimed in claim 1, wherein a maximum absorption wavelength (λₘₐₓ) of the compound is 420 nm to 440 nm.

13. The compound as claimed in claim 1, wherein the compound is a color material for electronic materials.

14. An antireflection film including the compound as claimed in claim 1.

15. The antireflection film as claimed in claim 14, wherein:
the antireflection film includes an adhesive layer and an antireflection layer formed on the adhesive layer, and
the compound is included in the adhesive layer.

16. The antireflection film as claimed in claim 14, wherein:
the antireflection film includes an adhesive layer, a dye-containing layer and an antireflection layer on the dye-containing layer, and
the compound is included in the adhesive layer, the dye-containing layer, or both.

17. A display device comprising the antireflection film as claimed in claim 14.
